(19) United States
(12) Patent Application Publication
(10) Pub. No.: US 2025/0369466 A1
(43) Pub. Date: Dec. 4, 2025

(54) BRACKET SYSTEM FOR JOINING

(71) Applicant: Andrew Ronald Plim, Flora Hill (AU)

(72) Inventor: Andrew Ronald Plim, Flora Hill (AU)

(21) Appl. No.: 18/874,563

(22) PCT Filed: Aug. 6, 2023
(86) PCT No.: PCT/AU2023/050733

§ 371 Date: Dec. 12, 2024

(30) Foreign Application Priority Data
Jun. 16, 2022 (AU) 2022901636

(51) Int. Cl. F16B 5/06; A47B 47/00; A47B 95/00; E01C 5/00; E01C 11/04; F16B 2/06

(52) U.S. Cl. CPC F16B 5/0614; E01C 5/005; E01C 11/04; F16B 2/065; A47B 47/0033; A47B 95/00; A47B 2230/03; F16B 2005/0678

(57) ABSTRACT

The present invention relates to a system of components for efficiently joining structural elements together to form multipurpose structures. The device utilizes brackets with screw jacks. providing a versatile and secure assembly solution. The brackets are designed for quick and easy attachment to the structural elements allowing for assembly and disassembly without causing damage to materials. The screw jacks offer adjustable tension ensuring a secure and stable connection between panels. Consequent advances in structural stability create opportunities to utilize homogeneous modern preformed structural elements. particularly reticular panels useful for modular construction. The system of components enables the creation of diverse orthogonal structures such as temporary partitions. exhibition booths, work benches and shelving units and containers. The simplicity and efficiency of the components along with the ability to interchange and reconfigure the panels makes it a valuable tool for a variety of applications.

### TECHNICAL FIELD

The present invention relates to an improved system for joining structural elements that has been found to be particularly useful in advancing joinery of both panels and members through a system of joint components with features for structure and adaptation to reinforce panel joins, facilitating innovative method and structural form, for use in assembly of landscape, furniture and general building constructs.

### BACKGROUND OF THE INVENTION

The present invention relates to building and construction of structures incorporating prefabricated units. The erection of structures from prefabricated units has hitherto been restricted in practice to a limited variety of materials and methods of joining owing to the availability of structural elements susceptible to mass production and the available methods of joinery for joining said structural elements.

The present invention has the objective of providing an improved system of joinery that will offer greater versatility of joining structural elements by facilitating the mechanical fixing of a greater range of prefabricated structural units, more particularly the capacity to mechanically join structural grade: panels and members: panels of stone pavers, timber panels suitable for bench tops, members of rectangular and square hollow section tube, members of timber, to provide greater array of possibility in joining said materials, to provide improvements in landscape construction, furniture construction, greater accessibility range of possibilities in joining materials for DIY construction and improvements in construction in general.

The present invention aims to provide benefits by avoiding predrilling hardwoods and masonry, overcome issues of related to mechanically joining brittle structural elements, particularly related to stone or thinner structural grade wood timber members and timber panels in general and members in general when joining close to the edge or fixing directly in to the ends of the wood grain which is prone to splitting: overcome concerns relating to hazards by minimizing silica dust by providing greater accessibility to existing stone panels in form of pavers that are a useful size for furniture construction without the need to pre-cut to size: overcoming the requirement to use tools to predrill metal an added complexity, that moreover ads safety concern and technical complexity that are particularly challenging to DIY enthusiasts such as: correct size drill bits suitable for the material and that will create the correct size hole diameter: avoid complexities relating to the best practice requirement of applying lubrication to maintain sharp drill bits, avoid the requirement for competent eye hand co-ordination and physical strength when installing screws into structural grade metal: the present invention will also overcome difficulties relating to holding in place multiple structural elements to create a multi-junction join of members or of member to panels of all of material of various types when constructing shelving or benches using existing available brackets and braces.

It is common knowledge that panel shaped materials usually need structural reinforcement when joining, that is why panel shaped materials are often limited to cladding of a substrate frame.

Besides the use of glues and bracing using nails and screws, methods of joining panels is rather limited, the methods to joining structural grade panels to members is further limiting both design and accessibility potential of materials and participants within the current state of the field of construction and assembly.

In developing the present invention an analysis of the existing structural grade building materials identified a commonality of thicknesses which was useful for engineering a solution to the prior listed array of concerns.

The summary the survey of common structural grade building materials identifies that they start at 20 mm or greater in thickness.

### Hollow Section Tube

An assessment of the major suppliers of metal products in Australia identifies rectangular and square hollow section tube of structural grade starting at 20 mm thickness.

Current methods of butt joining said tubing is by welding or in the case of square hollow section tube, by using joiners that consist of configuration of I, L, T and X shaped branches of square hollow section tube that fit within the inside dimension of the tube being joined. The issue with this type of joining is that it won't join panels within the joint hardware.

Another method involves using brace type brackets (possibly two: on each side) of flat plate to join in a straight linear or angles type (possibly two: one each side) and fixing the brace directly to the butt join with self-tapping screws or rivets. The right-angle brace may also be used for a T and X junction join. The problem with using flat or right-angle braces/brackets is that it requires the use of metal screws or rivets.

Self-tapping screws or rivets installations require the use of electric driven driver tools or drills and drill bits of the correct size to suit screws often of which DIY people may not possess. Also using electric drills or drivers to drill into metal requires a fair degree of strength and co-ordination, competencies that potential DIY participants may not have: further, predrilling into metal requires lubrication or the drill bit will go blunt. Drill bits need to be of the right size for the pop rivet and the pop rivet guns require maintenance, often rivets get caught with rivet pins that might not eject when the rivet gun is worn.

Welding another option on the high end of competencies, can be dangerous to those not trained, and does a require a fair degree expense for equipment including protection equipment such as a welders mask for the face and eyes and gloves for hand protection, grinders, welding sticks, electricity supply, primer and paint to protect the bare grinded steel and new weld as well as clamps to hold the tube members in place.

It is also worth noting the prior art relating to the art of joining RHS Rectangular Hollow Section brackets (Australian Registered Design 198704415, Design 201816824, Design 201816825) lack the features of a threaded hole for installation of a screw jack and lack of a rigid wall to support a screw jack. These brackets, although they have configurative form on appearance with the with the C cross section channel side walls of the L and T joiners that resemble parts of the system to be described in the next section, they are designed for conventional tech screw fixings or bolt style fixing that require drilling holes in the structural elements. The walls are pulled inwards against the structural elements when this conventional style of fixing is used, the walls do not need the structural integrity for the resistant force exerted by a screw jack style joint hardware. The fixing used within said design are anchored into the structural elements therefore is generally only suitable for joining the tube they were designed to be joining and materials that are more brittle.

### Timber

‘Timber development UK’ identifies standard sizes for softwood structural timber to be starting at 22 mm. The same organization further states that ‘structural seasoned softwood’ used for framing of residential construction starts at 35 mm thickness. Class 1 structural sawn softwood timber starts at 22 mm. Class 2, planed softwood structural timber starts at 44 mm: and the standard target dimension for trussed rafter members start at 35 mm in thickness.

‘Wood Products Victoria’ a timber products association in Australia, in its structural timber products guide, identifies structural seasoned hardwood starting at 35 mm and also in 45 mm thicknesses and unseasoned hardwood starting at 25 mm thickness, seasoned structural softwood starting at 35 mm thickness, unseasoned structural softwood starting at 38 mm thickness.

A common structural grade timber sold in the UK is an imported variety planned softwood milled to Canadian Lumber standards at 38 mm in thickness.

The publication ‘Timber development UK-merchant guide to selling timber’ identifies: Laminated hardwood kitchen worktop dimensions starting at 27 mm thickness. Further the same publication identifies that “most popular species of flooring timber to be at 20 mm thickness”.

As previously stated, the assessment of the timber size standards in both the UK and Australia identifies that timber member sizes are regulated by national standards of similar sizing all of which are 20 mm and above.

### Timber Member Joining

Current methods of butt joining timber members include directly fixing using screws or nails. The problem with direct fixing timbers 20 mm in thickness is that the timber is prone to splitting, especially if fixing directly into the timber grain at the ends of the members and especially if doing so with hardwood which although is stronger is more brittle. Predrilling before fixing does help, however it does require having the right size drill bit for the right size fixing. Once drilled a further driver is required to install the screws or nails, either using a electric driver, manual hand held screw driver or hammer requiring both co-ordination and hand strength. The competencies and tools DIY enthusiast may not have. Direct screw and nail fixing of small profile timbers such as 20 mm thickness usually requires reinforcement with glues, that are messy and of which DIY enthusiasts don't have. Even after fixing with glue if being used for furniture application the direct fixing with glue is not enough.

And none of the above methods allow for joining pavers.

### Benchtops/Tabletops

An International Supplier of stone states: bench tops made of stone identifies that fragile stone may require a full sub-top to support the stone. Generally, sound varieties of granite, marble, bluestone and sandstone can be used in thickness of 20 mm and greater without use of a sub-top as long as back to front supports are installed along the bench every 600 mm.

An Australian supplier identifies that the minimum thickness of bench tops across all materials to be on average 39 mm thick ultimately it is determined by the buyer.

A concrete benchtop supplier in Australia has identified in their frequently asked questions section of their website that the minimum thickness for concrete bench tops to be at minimum 25 mm. (www.lovecrete.com.au)

### Concrete Sleepers

A survey of concrete sleepers in Australia identifies that they are available in thicknesses starting from 50 mm. Sleepers like pavers and timbers and metal tube are currently rated to national standards relating to breaking strength and according to application.

### Concrete Sleeper Joining

The currently methods of butt joining sleepers is by using configuration of “C” or “H” cross section channel posts that are required to be installed in a hole in the ground usually with the use of a concrete footing. There is no other method of joining sleepers that I am aware of.

It should be noted that if one was to consider installing a garden bed on an existing concrete paved area they would need to cut holes in the concrete to install the posts.

### Pavers

Pavers have come to be known internationally to start at 20 mm thickness for natural stone and porcelain pavers. 30 mm thickness has come to be known to be the next size up for natural and porcelain pavers, the 30 mm porcelain paver being a relatively new product for high traffic and heavy-duty areas, having a 29000 N breaking strength compared to a 10,000 N breaking strength for 20 mm porcelain pavers (according to standards EN 1339U30). 10000 N equates to about a 1 tonne breaking strength. There is no doubt that porcelain pavers are an incredibly strong material, making it ideal for its wide variety of its current applications such as driveways, pool decks, patio and more.

New release versions of 20 mm porcelain pavers are available as planks up to 1200 mm*400 mm and made in a wide variety of colours and textures such as timber printed graphic. Other now more common sizes of porcelain pavers include 600×400 mm, 800×400 mm, 600×600 mm, 900×900 mm.

The benefits of using pavers, especially porcelain pavers as a construction material is:
Fire resistance
No oiling or ongoing maintenance
Won't twist, warp, split, crack,
No fading or colour change
No decay or insect attack
No scratching or scuffing,
No grease or oil staining
Mold and mildew resistance.
The are load rated according to standards.
Are dimensionally regulated according to standards.

In Australia breaking strength of concrete pavers are classified according to national standards based on thickness categories:
40 mm, 60 mm, 50 mm, 60 mm, 76 mm, 80 mm

A survey of paver materials identifies that pavers are a structurally rated building material with thickness starting at 20 mm and greater.

When surveying existing prior art relating to methods of joining building materials one of the obvious standouts is in the inadequacies of existing brackets to adequately facilitate the joining pavers together and to other forms of structurally graded building materials.

Pavers generally come in industry standardized dimensions and are mass produced making them a suitable source of material for assemblage. Currently pavers have limited use outside of their intended purpose as floor coverings. It is presumed due to a lack of a suitable system of joinery that can facilitate the practical application in the fields of construction and assembly in general.

### Joining Pavers

Currently the only method of joining pavers is by using bonding them flat to an existing substrate with the use glue or cement-based mortar, both of which can be messy and toxic. Mortar cracks under pressure from movement. Mortar based masonry usually requires a concrete footing, string lines, a general high degree of technical competency. And the joins once set can't be modified or adapted easily.

Stone construction is seen to be more practical for permanent immovable construction due to both the weight of the material and the current available methods of joining masonry being permanent fixing methods. Being able to disassemble and reassemble masonry structural elements is an advantage for application that are less permanent which has not been perfected in the field of masonry yet, not beyond glass joinery.

### A Survey of Other Brackets and Joiners

A survey of the art bracket componentry for glass panels identifies pool fencing and shower screen glass joiners with a H section profile. The middle wall of the H profile creates a gap between materials being joined due to the fixing bolt passing through the ‘H’ section wall: being made of precast material they are quite bulky for the capacity of the bracket that is restricted to 12 mm thickness. This form of joining component is not suitable with joining the prior mentioned structurally rated building materials for the assembly of landscape constructs, furniture and other constructs to be later described as an outcome of the present invention.

This form of prior art uses a grub screw as a form of ‘Holding Bolt’ to apply pressure to the side of the glass pressing it against the side wall of the joining component. The use of a threaded bolt in the context of applying pressure is termed in engineering a screw jack. A screw jack provides the ability to adjust pressure to the surface of the material without penetrating the surface. The integrity of the side walls/retaining plates of components that hold screw jacks require extra consideration due to the tension. A noted feature of the embodiment used in glass joiners is that the threaded holes placed near to the fold, as placing them further out from the edge would create extra flex on the wall due to leverage effects. Being close to the edge of the glass being joined is not such an issue as grub screws have a nylon tip that cushion surface contact. When joining previously mentioned structural elements, nylon tips may not be suitable, and the position of the grub screw ideally should be further from the edge of previously mentioned more brittle timber and concrete structural elements.

joining brackets made of caste are more prone to breaking (rather than bending), as a result caste plates are used to clamp the structural elements together as opposed to withstand resistant force. The cast body maybe have benefits for mass production costing and may be acceptable in a fixed position, however, under the strain holding heavy weight using resistant force from screw jacks to create the hold the cast body would soon break. Cast being high tensile is less likely to flex and so is prone to breaking under pressure, also as a consequence of this aspect it is noted that the embodiments of glass joiners tend to be more bulkier.

In systems theory it is known that a minor adjustment in the component's features can have a disproportional effect on the emergent outcomes. Size as a catalyst to the proliferation of emergent outcomes relating to a system of joinery exemplifies this notion, as will be demonstrated in this proceeding specification.

Prior art indicates that pavers have not emerged from the 2-Dimensional plane due to a lack of a practical system of joinery.

As will be explained in the proceeding patent specification that intends to describe a joinery system that will initiate 3-Dimensional Paving as an art form and advancing the art of joining of existing commonly available structurally graded structural elements by overcoming issues relating to butt joining existing structurally graded: timbers, RHS and SHS tube and concrete sleepers by eliminating the necessity to dig holes to install uprights for joining.

### Assessing Paver Constructs

Being able to use pavers to build furniture such as shelving would have benefits: as it would be strong, could be hosed down without rotting, warping or deteriorating from the sun. Generally, masonry retainer walls assembled from masonry blocks or bricks, use block or bricks of similar width and height for stability. Masonry block or brick walls are quite thick, taking up valuable garden space in small gardens.

An issue of assembling garden walls with masonry blocks or bricks with mortar, is if the ground moves the mortar cracks: mortar joined masonry can also get messy during installation and once installed the configuration of the garden walls is not easy to change, with people being ever more transient adaptability and modification is a virtue to modern living that current methods of building garden beds using masonry lack.

### Further Refining Design of the System of Joinery

Further, a system of many components is costly in manufacturing set up costs, being able to efficiently achieve cost reductions based on product modification that allow components to be manufactured from the one set of tooling is a valued modification, the present application outlines how the joint hardware ‘partial wall’ modification not only creates efficiencies in the manufacturing process but also enhances versatility of use of I, L, T joint hardware to be described as part of the present invention.

Being able to add color options is a valuable attribute for furniture design and coating components for weather proofing is a valued option for product with intent to be used outdoors. Fine threads associated with screw jacks can occasionally be problematic with getting clogged with coatings such as paint, powder coating. threads installed directly into componentry adds a significant cost, especially on thicker sheet metal and when installing multiple threads such as to be the yet to be described ‘X’ shaped joint component or post. A solution to overcome these issues is to be described by a feature that facilitates a removable screw jack sub-assembly.

### SUMMARY OF THE INVENTION

The present invention relates to a system of joinery based on a range of joint hardware that is revolutionary for facilitating the joinery of structurally rated members and panels. The embodiment of the hardware features capacity for that make it compatible with a wide range of currently available structurally rated building materials including structurally rated RHS/SHS metal tubing, structurally rated timber members, structurally recommended thickness stone or timber panels to be fit for purpose as bench/tabletops, pavers.

The capacity of the joint hardware is dictated by the joint hardware retaining plates that are separated by a distance that facilitates the fitting of previously mentioned structural elements for use in construction and assembly of furniture, garden walls, partition walls, landscape constructs, shelving and more. The combination of the distance between retainer plates: the rigidity of the retainer plates: the joint hardware's capacity for the installation of screw jacks in the form of threaded holding bolt that clamp the said structural elements within the joint hardware: and the configuration of component of the 4 main components is what makes the joint hardware so versatile and practical application, with the outcome being impressively improved construction designs that are accessible and achievable to a broad range of construction and assembly enthusiasts.

Primarily the core components of the system consist of joining brackets with the form of retaining plates that provide a holding space for the structural elements to be joined. The joining of the structural elements is achieved by threaded bolts featured in the retaining plates, that apply pressure to create a clamping hold. Threaded holes in the retaining plates of the of the joint hardware for installation of the threaded bolt is referred as the screw jack. The screw jack exerts an adjustable form of pressure against the structural elements pressing on the surface, forcing the structural elements against the opposing wall, as opposed to penetrating the surface of the structural element as conventional mechanical fixing using screws and nut and bolts. By selection of the appropriately sized joint hardware users are able to easily and quickly joint said structural elements without needing tools and the exposure to hazards that are associated with conventional joining methods are also minimized.

The nature of the screw jack and its gentle approach to fixing makes it also a suitable for repeat assemble and disassemble of temporary structures.

The main types of joins are achieved by four variations of ‘C’ cross section profile configurations:
1) ‘I’ Straight joint component configuration.
2) ‘L’ Corner joint component configuration
3) ‘T’ Junction joint component configuration
4) ‘X’ Cross junction component configuration

The four components are used to assemble orthogonal structures. Structural elements fit between retaining plates, the retaining plates are joined by a central joining plate between to form the C cross section profile channel type of embodiment.

The central plate has the configurative structural form of I, L, T, X profile when viewed flat from above; the retaining plates protrude at 90 degrees form each longitudinal edge of the said profiles, in the same direction to form the said configuration of channel shaped embodiments.

Threaded holes or nut seats are positioned in the retaining plates of the joint hardware for the installation of the screw jack bolts.

The ‘I’ joint component features two threaded holes or nut seats located in either of the retaining plates for the installation of the holding bolts of the screw jack. Said threaded holes or nut seats are separated a distance apart of at least 16 mm on the plane parallel to the central connecting plate between retaining plates to provide capacity for placing one structural element at each holding bolt and providing capacity for joining structural elements by said holding bolts.

The ‘L’ Joint component features at least two threaded holes or nut seats located in either of the retaining plates, with one on each branch of the L shape profile, for the installation of the holding bolts of the screw jacks.

The ‘T’ Joint component features at least three threaded holes or nut seats located in either of the retaining plates, with one on each branch of the T shape profile, for the installation of the holding bolts of the screw jacks.

The ‘X’ Joint component features at least four threaded holes or nut seats located in either of the retaining plates, with one on each branch of the T shape profile, for the installation of the holding bolts of the screw jacks.

The threaded bolts or nut seats for facilitate the installation of the holding bolt of the screw jack which facilitates holding one structural element at each holding bolt and providing capacity for joining multiple structural elements within the said joint hardware.

### Creating Larger Panels from Smaller Sub-Panels

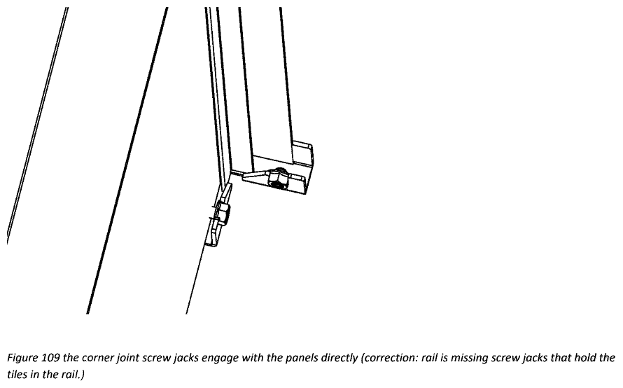

An embodiment consisting of retaining plates that form an extended length of ‘C’ or ‘H’-cross section profile used to join multiple structural elements to form a larger panel structure (Refer to FIG. 109-117—multi-stack rail system).

The context of combining screw jacks with C or H cross section profile channels lengths are useful for creating larger panels out of multiple structural elements. The side walls of the C-section act as retaining plates: threaded holes or nut seats for placement of screw jack holding bolts are featured along the length of either of the opposite facing retaining plates that form the C cross section side walls. In the case of the nut seat version a flanged nut is inserted into a nut seat to create the threaded hole.

The ‘C’ cross section profile for joining at the ends of stacked structural elements.

The H cross section profile effectively being a two C cross section profiled channels juxtaposed back-to-back for butt joining two stacks of structural elements in a straight join.

C-section rails with or without screw jacks can be used to hold multiple sub-panels together to form a larger panel that can be used to assemble stacked structural elements into wall panels structures and the four joining components can be used to join said elongated rails in by fitting at each end (I, L, T, X). refer to FIGS. 106-113 & 117.

Further, assembled panel structures can be reinforced with members suitably sized to fit the retaining plates, providing structural support to assembled constructs.

### Distance Between Retaining Plates

The distance between retaining plates of the joint hardware components is specified to suit commonly available structurally rated structural elements used within the building and construction industry the structural elements mentioned the background section.

The distance between opposite facing retaining plates is to be between 20 mm and 130 mm.

### Detachable Screw Jack Assembly

The installation of a nut seat in the retainer plate is an inventive feature of joint hardware not seen previously. A nut seat allows the threaded hole of the screw jack to be detachable and replaceable, a valued feature when coating the joint component, especially valued by DIY enthusiast that want to customize the joint hardware or want to apply a coating for weather/salt resistance.

The nut seat provides the basis for detachable screw jack assembly consisting of a threaded flanged nut instead of the threaded hole being directly installed into the retaining plates.

The joint components can be painted, powder coated, galvanized or any other coating whilst avoiding any defective thread issues.

With the consideration of the value of long-life usability for temporary assemblies and the durable requirements of users from the construction trade environment the ability to easily maintain the joint hardware and overcome defective thread issues does have user benefits.

The manufacture of joint components with nut seats as opposed to a threaded holes is more cost efficient therefore joint hardware can be manufactured with more screw jack placement options providing choice for better alignment or position of the screw jacks for improved construction and assembly.

The joint hardware has three main nut seat types:
1.) Hexagonal hole nut seat (‘Hex-hole’ space)
2.) Slotted space nut seat (‘Slot-space’)
3.) Hexagonal slot nut seat (‘Hex-slot’ space)

The hex-hole nut seat version consists of a hexagonal space for placement of the threaded hex headed flanged nut, said nut to be placed with the hexagonal head fitted into the matching hexagonal hole from the inside of the joint component, the flanged nut acting as a thread installation for the holding bolt to be threaded into. The flange of the nut stops the nut from passing through the retaining plate and the hex shape head of nut stops the nut from rotating as the bolt is tightened. (Refer to FIGS. 5 & 7—Hex-hole—screw jack assembly)

An issue with the hexagonal hole screw jack placement seat variation can be seen to occur with the smaller sized components. as it can be difficult to get access between the retainer plates of the said channel type components for some people. especially with the smaller capacity components with a narrower distance between retainer plates.

A solution to make the flanged nut installation easier is to install a ‘Slot space’ nut seat the retainer plate. so the flanged nut with bolt mounted within can slide into position from the outer edge of the wall of the component. with the slot spacing being of appropriate width to allow the hex head of the nut to pass through yet stop the nut from rotating. (refer to FIGS. 6 & 8—‘slot space’ screw jack assembly). Pending there being adequate space between the inner side of the retaining plate and the structural element positioned in the joining hardware. the slot space allows the flange nut to be installed after the structural elements have been placed into position which has benefits when using the joint hardware with larger/heavier structural elements.

Although there is benefits to the straight slot nut seat there is a risk of the flange nut potentially sliding out perhaps under certain scenarios or over time. An added feature to reduce the risk of this happening is to create an indentation in the wall where the flange nut is to be seated. This would lock the flange nut in place to a degree but depending on how tight the screw jack was done up it may still be possible to slide under certain circumstances. Creating a recess has other benefits of reducing the interference with the structural elements in the holding space. Creating the indentation all the way along the slot space further allows the flange nut to be inserted when the structural element has already been placed in the joint hardware more easily. leading to an easier and safer assembly process when using the nut seat version of joint hardware.

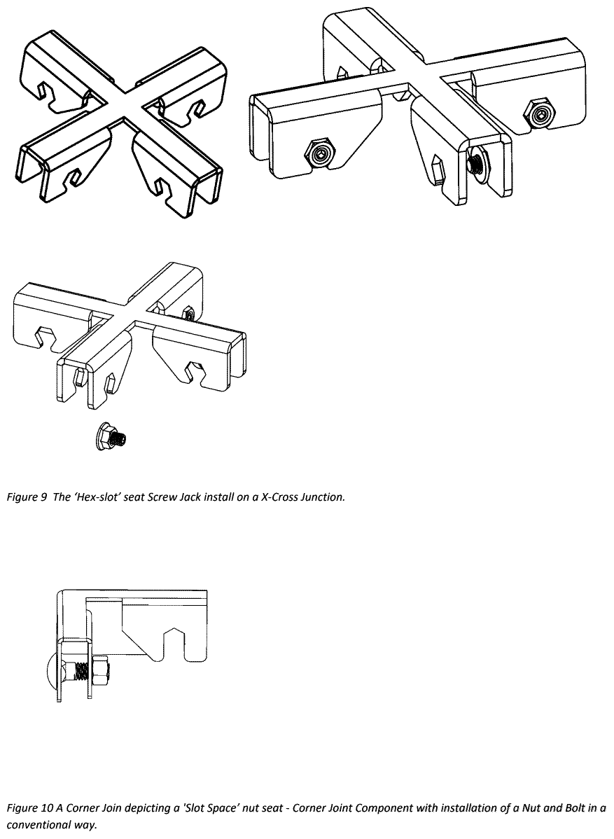

The ‘Hex-Slot’ nut seat variation: is a merge of the previous two designs (Hex-hole & slot space) mentioned. whereby the side wall of the component features a hex hole that matches the hex-head flange nut to be inserted. further. a slot is formed between the hex-hole and the edge of the retainer plate. in such a way that the slot space is slightly wider than the threaded bolt yet narrower than the hexagonal hole so that the flanged nut is locked when seated in position. By threading the bolt into the flange nut just a few turns. the protruding length of the threaded bolt acts as a handle to position the flange nut in the hex hole where it locks into position (Refer to FIG. 9—‘Hex-slot’ screw jack assembly). This form of nut seat addresses any concern of the detachable screw jack assembly sliding out. whilst also providing a method for easy installation of the flange nut in the smaller sized components where it may be difficult to access for some people due to finger dexterity.

### Engineering to Suit Application

By upscaling the body of the butt joint hardware components and increasing structural integrity for heavy duty applications the present invention of the bracketed system of joinery has never been seen before, leading to an explosion of application potential. Much like adding oxygen to petroleum. The oxygen is not dramatic on its own yet adding oxygen to some elements can lead to a highly reactive outcome.

The I, L, T, X Joint Hardware with screw jacks to clamp hold elements for construction and assembly of structurally rated structural elements such as Timbers, RHS/SHS tube, panels suitable for bench tops, pavers and sleepers leads to new creative construction designs that can be built as an outcome of the inventive system of joinery.

By increasing the distance between c-section retaining plates the components gain capacity for holding larger structurally rated structural elements. By increasing the strength of the retaining plates, the components develop the structural integrity that allows for the screw jack to be position further away from the structural element edge where brittle cementitious panels are prone to breaking. When assessing the prior art that utilizes screw jacks, primarily glass joiners, it can be noticed that the screw jacks are placed close to the fold of the sheet metal where the wall is most rigid, it should also be noted that this position translates to being closer to the edge of structural elements being joined. This is not so much of an issue with hardened glass as it would be with other types of material such as timber panels or cementitious panels that are more brittle. Therefore, the reengineering to position the screw jack bolts further away from the edge of the structural elements, being further way from the fold line, along with the distance between threaded holes separated on the same plane as the central retaining plate that allows multiple structural elements to be joined between the retaining plates: are minor features that have important implications to achieving the inventive step of the present application.

A more invisible feature contributing to the inventive step is the need for rigidity of the retaining plates, the leverage effects of the position of the screw jacks and the relationship to torsion effect of the retaining plates and therefor the screw jacks ability to hold is a context which can be overlooked by appearances alone.

The bracketed system of joinery outlined in this application overcomes the limitation of distantly related prior art to facilitate the joining and assemblage of structural elements such as:
Stone pavers
Concrete pavers
Porcelain pavers.
Members of timber and RHS (Rectangular Hollow Section/Square Hollow Section
Concrete sleepers
Timber panels

### Demonstrating Practical Outcome Due to Instrumental Changes to Components

As acknowledged in Systems Theory, minor adjustments to the components of a system can have a disproportionate effect on the emergent outcomes.
increasing the component sizing, more specifically the space between retaining plates of the channel type components for the Main Four range of joining components.
introducing the elongated ‘C’ and ‘H’ cross section components.
enhancing the rigidity of the walls by increasing thickness and/or methods of increasing the stencil strength of the retainer plates.
introducing an nut seat version for durability and added optional screw jack placement.

The combination of features contribute to the bracketed system of joinery to join structural grade materials with minimal tools, reduced hazard, with less competency required, combine a greater range of materials in build concepts, to assemble an innovative range of practical concepts that can be easily assembled and disassembled.

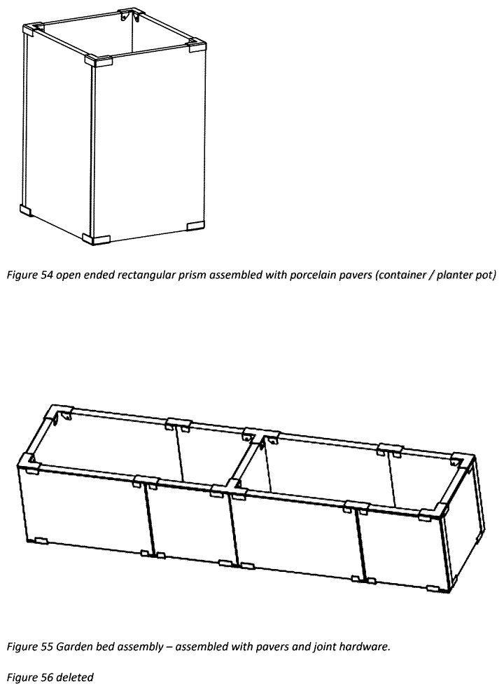

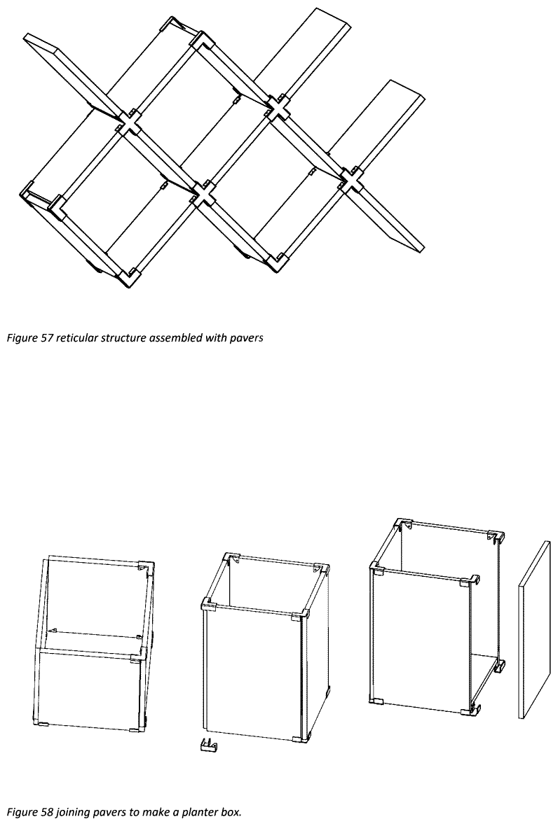

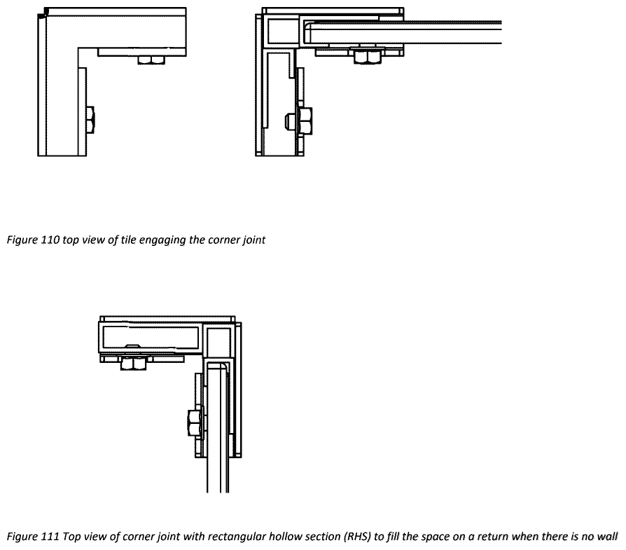

Below are some stand-out constructs that contribute to evaluating the outcome of the present invention.
Table (FIG. 85-88)
Stands (FIG. 54)
Shelving. (FIG. 57, 58, 90-95)
Storage racks. (FIG. 58)
Containers/Planter Pots/Laundry Container/assembled pavers. (FIG. 55, 59-6)
Garden Beds assembled pavers/sleepers without digging holes. (FIG. 56)
Retainer walls/Garden edging assembled pavers or concrete sleepers. (FIGS. 105, 106 & 107)
Concrete Form Work assembled with pavers. (FIG. 117, 120)
Hoarding/partitions walls using plywood/stone panels as structural elements. (FIGS. 110-116)
Walls using Hebel (Aerated) panels
Work benches. (Refer to stand, in larger size)
Outdoor Chests made from pavers. (FIG. 76)
Drain Pit made from pavers (FIG. 78)
Steps/stairs (figure

The inventive step of the bracketed system of joinery is further demonstrated by the joint hardware specified being having features not previously that facilitate construction not previously seen. It might not be obvious when looking at the joint hardware however when the build concepts are assessed it soon becomes obvious that there must be features that are not obvious that contribute to the surprising outcome.

Further there are less obvious outcomes that are not obvious when looking at the components, being:
Constructs can be assembled with minimal tools required besides and Allen key for tightening a bolt.
Assembly multiple elements is much easier as the components act as a clamp to elements together. Even more pleasing is the fact that these clamps are ergonomic enough to be left as a permanent feature.
Effort and complexity is required for especially metal member and hardwood members (RHS/SHS members) as no pre-drilling pilot holes is required, no need to weld metal members
No foundation is required for joining pavers, no mortar means no cracking joins to masonry garden beds made with pavers.
No digging of holes are required for assembling sleeper garden as the screw jacks join the sleeper in a self supporting manner.
build constructs made with pavers have benefits such as:
   Fire resistance
   No oiling or ongoing maintenance
   Won't twist, warp, split, crack,
   No fading or colour change
   No decay or insect attack
   No scratching or scuffing,
   No grease or oil staining
   Mold and mildew resistance.
   Are perfect for outdoor use.

### BRIEF DESCRIPTION OF THE DRAWINGS

### Examples of Sizes

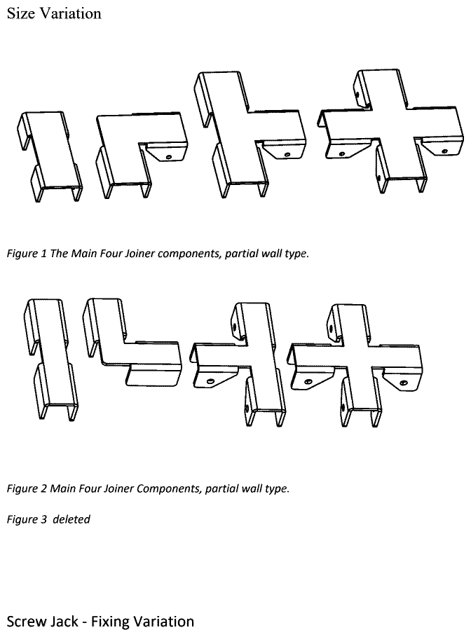

FIG. 1 The Main Four Joiner components

FIG. 2 Main Four Joiner Components

FIG. 3 (deleted)

### Examples of Screw Jack Installation Types

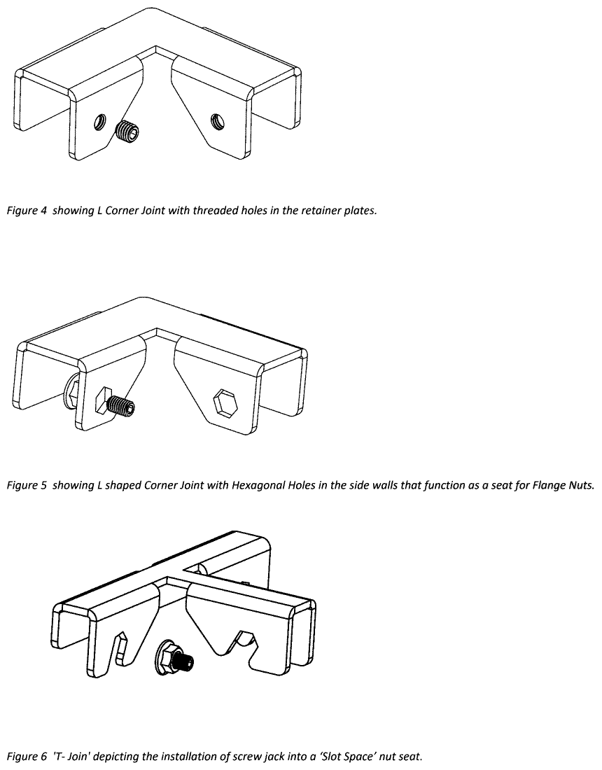

FIG. 4 The ‘Corner Join’ depicting the ‘Direct threaded holes’ in the walls of the C-section that have been tapped for the insertion of a Grub Screw that functions as a ‘Screw Jack’

FIG. 5A ‘Corner Join’ displaying the Hexagonal Holes in the side walls that function as a seat for Flange Nuts, an alternative thread installation for the Screw Jack assembly.

FIG. 6A ‘T-Join’ depicting the ‘Slot Space’ Version with the space in the wall removed for sliding the Flange Nut in to position from the edge.

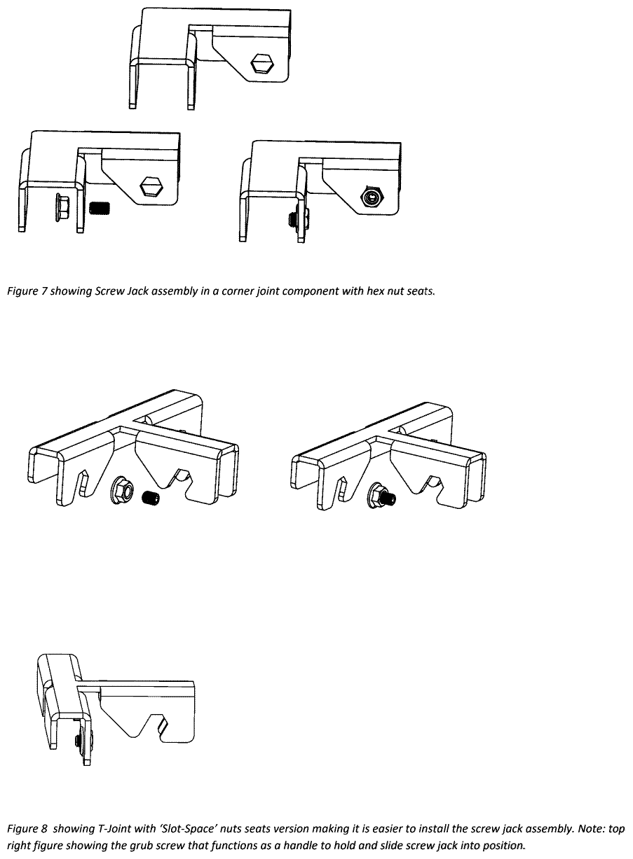

FIG. 7A side view of ‘Corner Component’ depicting the process of installing the Screw Jack assembly.

FIG. 8A T-Join depicting a range of views of the ‘Slot-Space’ version, making it is easier to install the screw jack assembly in the small components.

FIG. 9 The ‘Hex-slot’ Screw Jack placement depicted on the 10 Series X-Cross Junction.

FIG. 10A Corner Join depicting a ‘Slider Space-Corner Joining Component’ with installation of a Nut and Bolt in a conventional way.

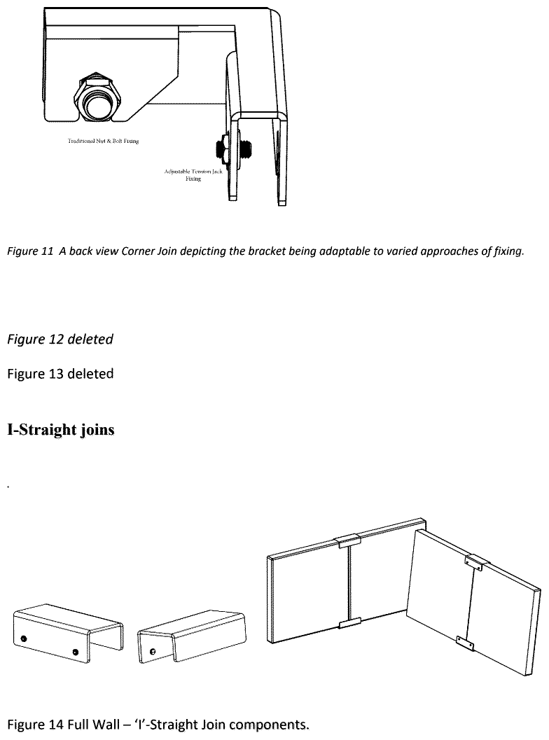

FIG. 11A back view Corner Join depicting the bracket being adaptable to varied approaches of fixing.

FIG. 12A Front view of the Corner Joiner Component showing versatility with the slot space on both sides.

FIG. 13A Corner Joiner Component with Screw Jack Fixing on the external facing wall of the Corner.

### ‘I’—Straight Joins

FIG. 14 Full Wall—‘I’-Straight Join components for joining structural elements in a Linear Butt Join fashion.

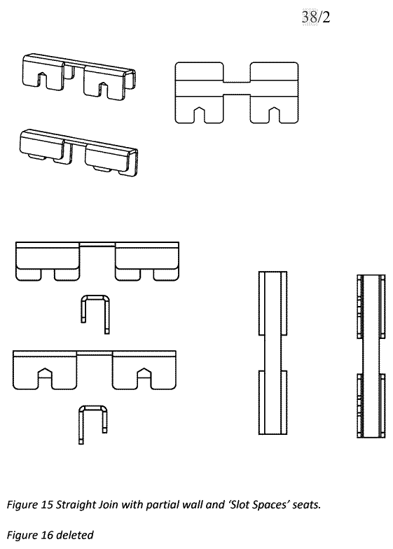

FIG. 15 Straight Join with ‘Slot Spaces’.

FIG. 16—deleted

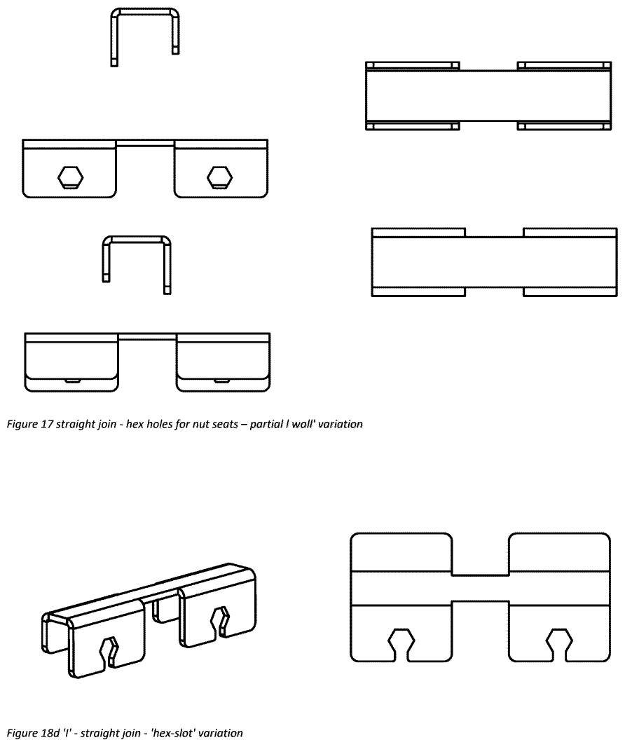

FIG. 17 20 series straight join ‘I’ with-hex holes for screw jack assembly—partial I wall’ variation

FIG. 18d the ‘I’—straight join—‘hex-slot’ variation.

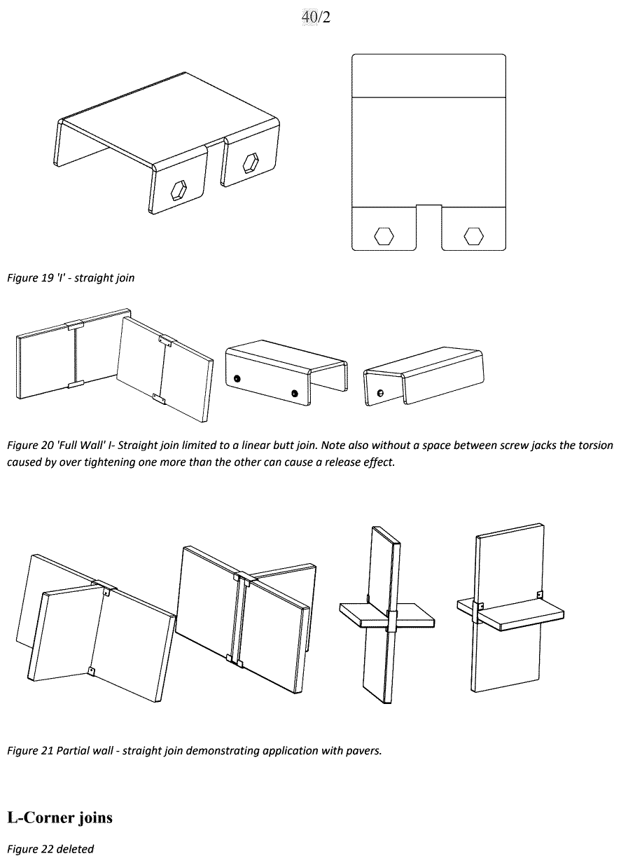

FIG. 19 80 Series ‘I’—straight join.

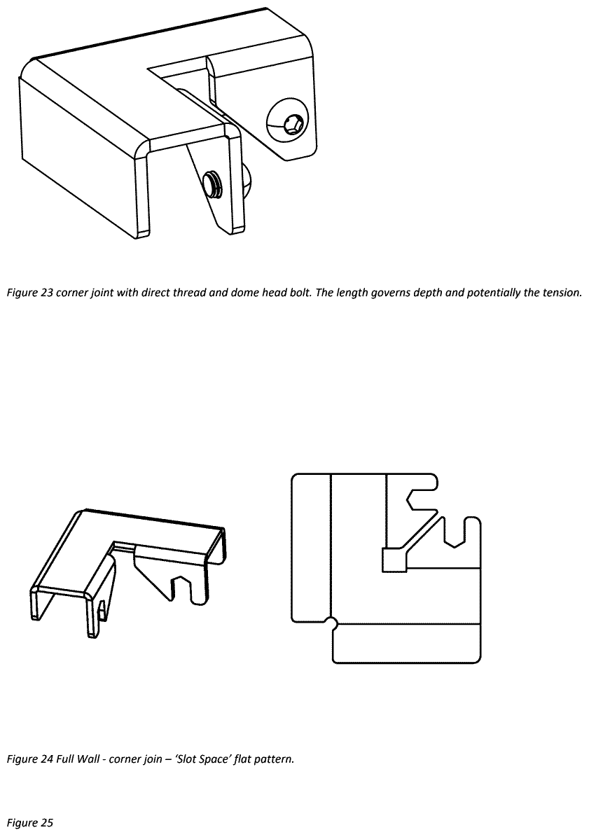

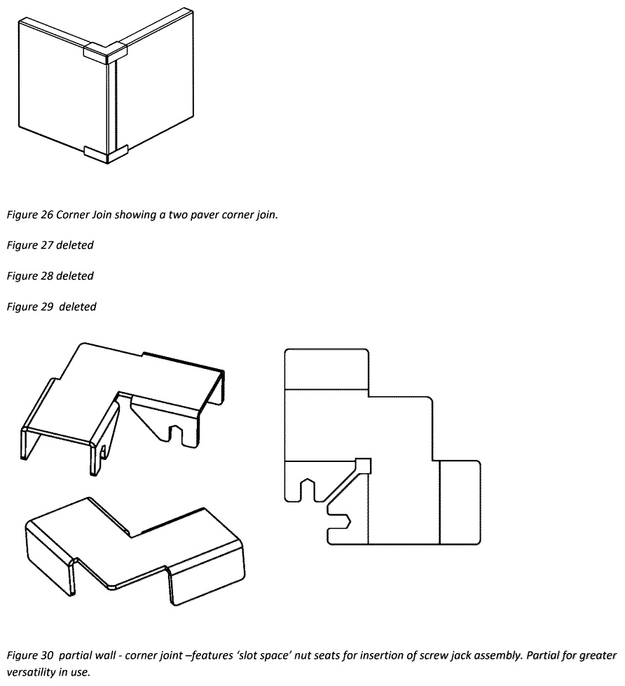

FIG. 20 ‘Full Wall’ I—Straight join limited to a linear butt join.

FIG. 21 Partial wall—straight join demonstrating application with pavers.

### L-Corner Joins

FIG. 22—deleted

FIG. 23 corner joint with direct thread and dome head bolt.

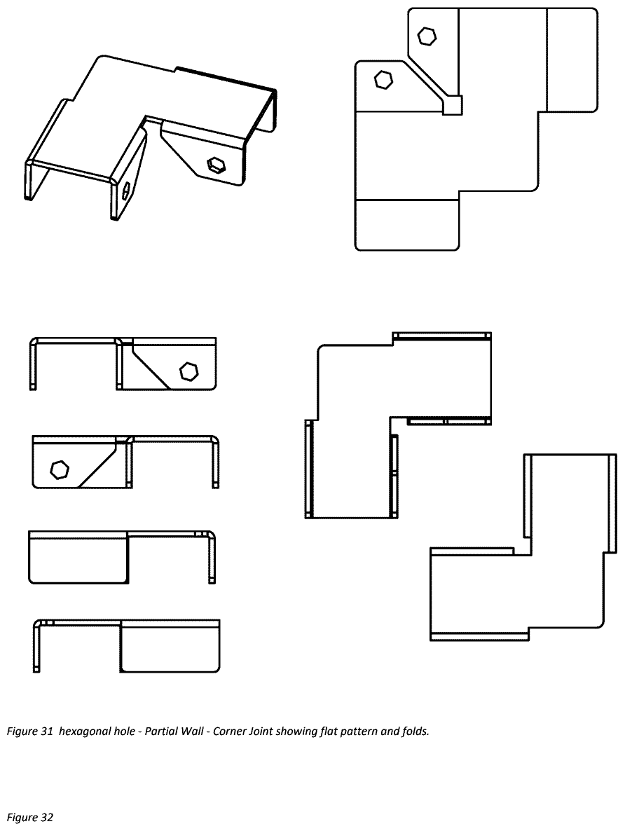

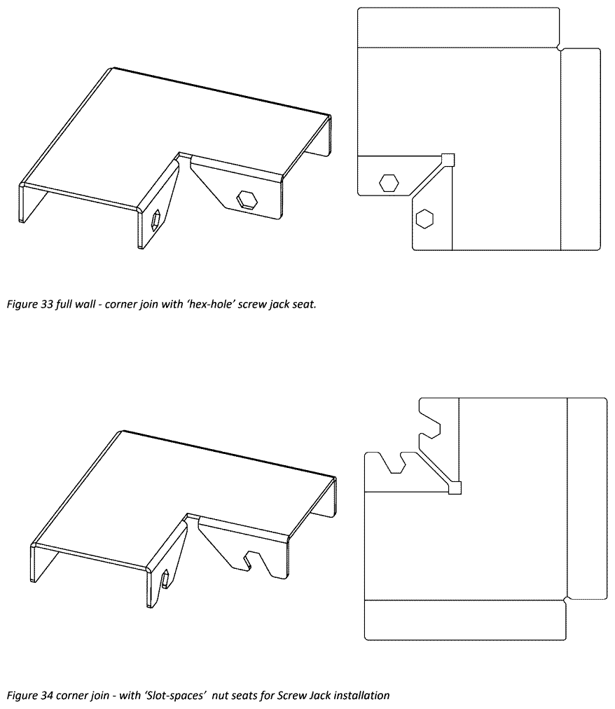

FIG. 24 Full Wall—20 Series corner join—‘Slot Space’ flat pattern.

FIG. 25 the ‘Hex-slot’ version.

FIG. 26 Corner Join FIG. 27 Partial-wall—Corner Join.

FIG. 27—deleted

FIG. 28—deleted

FIG. 29—deleted

FIG. 30 40 Series—partial wall—corner joint—suitable for joining concrete pavers or double layered porcelain pavers, features ‘slot spaces’ for insertion of screw jack assembly. Partial for greater versatility in use.

FIG. 31 40 series—hexagonal hole (M6 size)—Partial Wall—Corner Joint demonstrating flat pattern and folds. The wall removed at the apex allows for greater versatility in use.

FIG. 32—deleted

FIG. 33 80 Series—full wall—corner join with ‘hex-hole’ screw jack seat. 80 Series rage us suitable for joining concrete sleepers that typically have thickness of 75-80 mm. (refer to FIG. 105 for assembly demonstration)

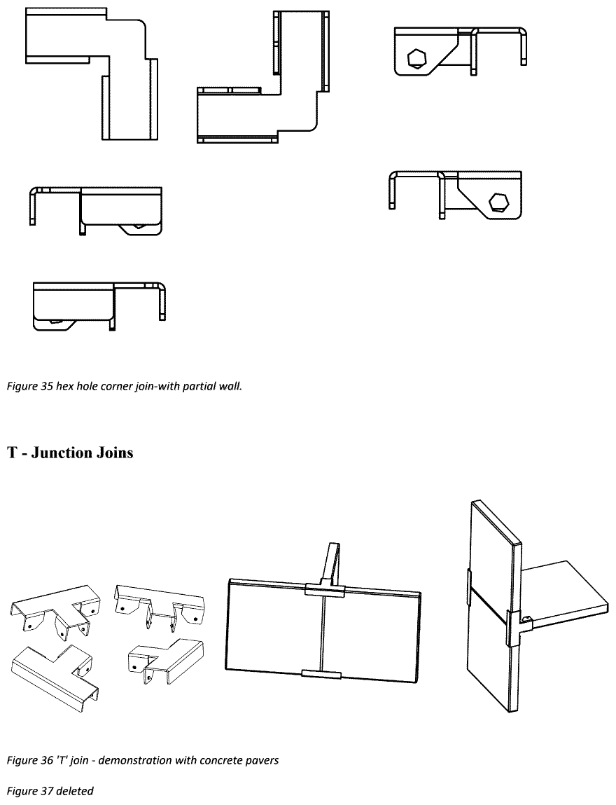

FIG. 34 80 Series corner join-with ‘Slot-spaces’ for Screw Jack Insertion.

FIG. 35—deleted

### T—Junction Joins

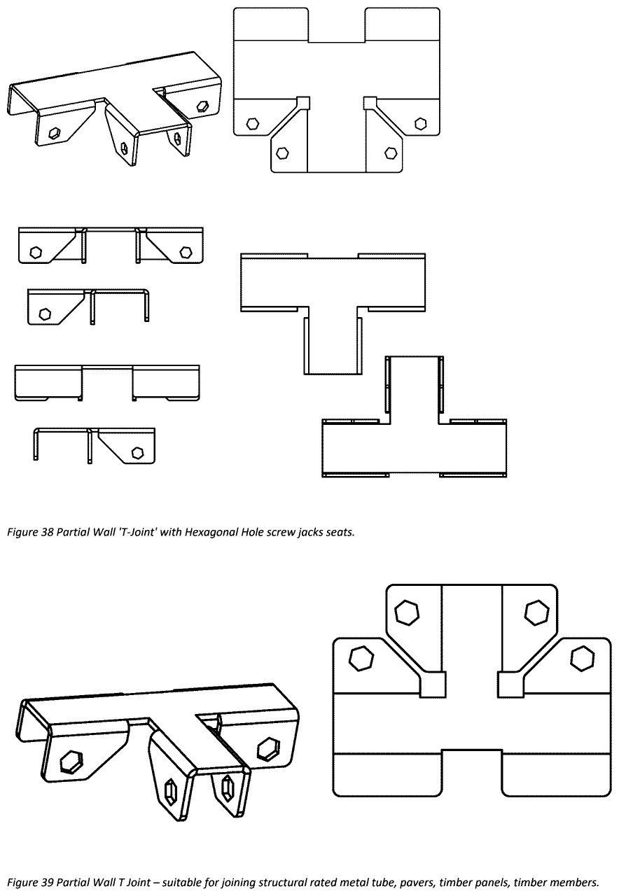

FIG. 36 40 Series—Full wall—‘T’ join—demonstration with concrete pavers

FIG. 37—deleted

FIG. 38 40 Series—Partial Wall ‘T-Joint’ with Hexagonal Hole screw jacks seats.

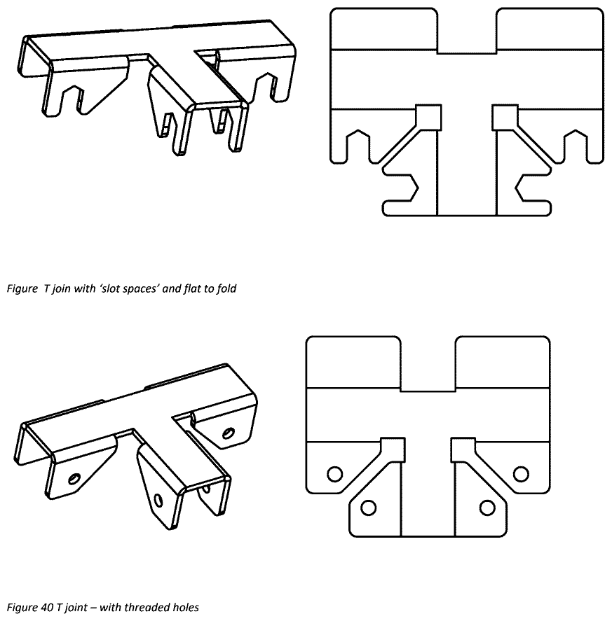

FIG. 39 20 Series—Partial Wall T Joint—suitable for 20 mm porcelain pavers and 19 mm plyboard.

FIG. 40 20 Series—T join with ‘slot spaces’—flat to fold

FIG. 41 20 series T joint—has 4 threaded holes (creating threaded holes can be labour intensive process and threaded holes can be problematic when painting or galvanizing the joiners)

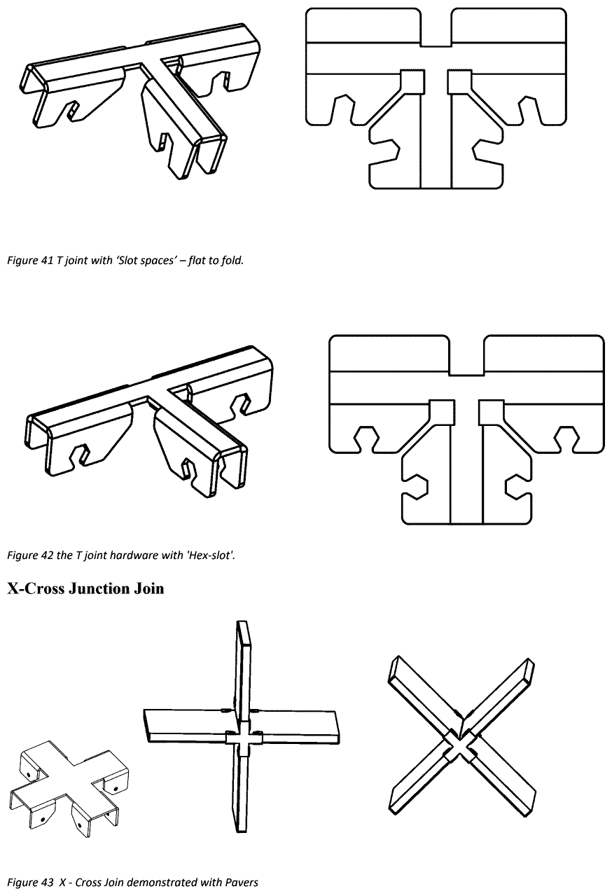

FIG. 42 10 Series T joint with ‘Slot spaces’—flat to fold. (Note: the square space in the corners allows for the caulking of joins.)

FIG. 43 the ‘Hex-slot’ locks the screw jack assembly in the hex space to it cannot slide out. The head of the flange nut mounts into the hexagonal space.

### X-Cross Junction Joins

FIG. 44 40 series X—Cross Join demonstrated with Pavers

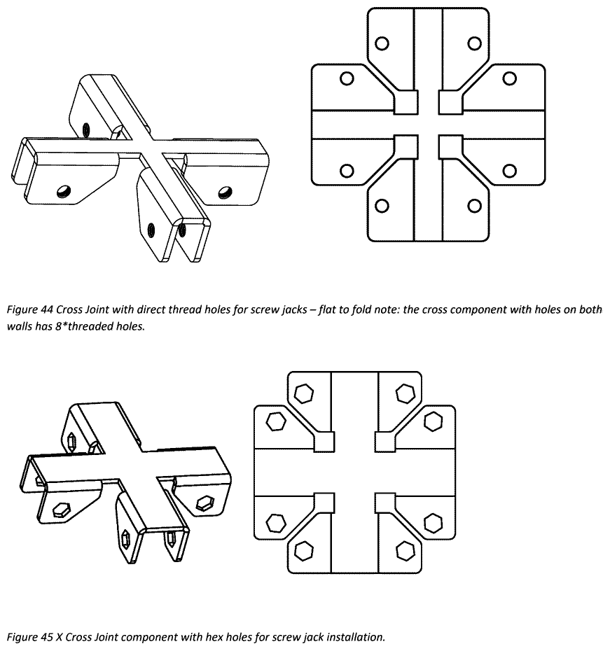

FIG. 45 10 Series Cross Joint with direct thread holes for screw jacks—flat to fold (suitable for tiles) (note: the cross component with holes on both all walls has 8 threaded holes, adding a significant portion to the cost. Having holes on one side of each branch, reduces cost however it does compromise the ability to align the structural elements in assembly)

FIG. 46 20 Series—X Cross Joint component with hex holes for screw jack installation. (Note this version in not practical for the 10 series range as the distance between walls is too small for placement of the flange nut)

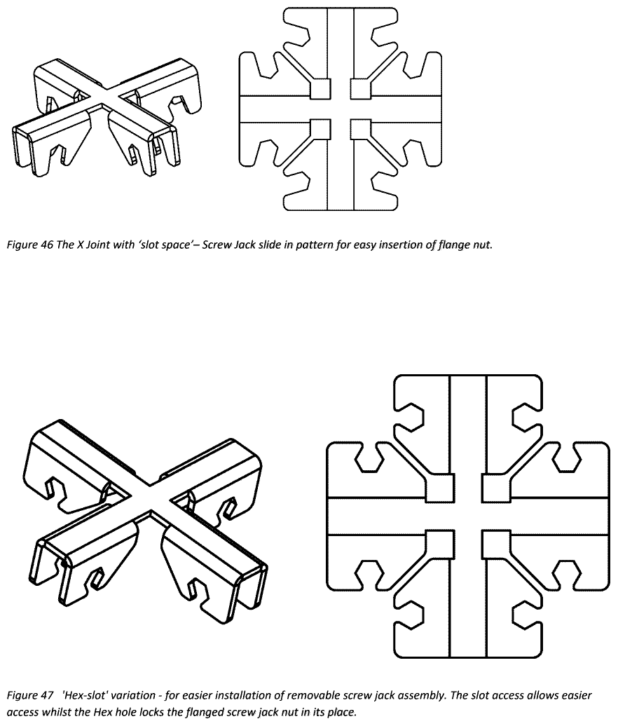

FIG. 47 The 10 series X Joint with ‘slot space’—Screw Jack slide in pattern for easy insertion of flange nut.

FIG. 48 10 Series ‘Hex-slot’ variation—for easier installation of removable screw jack assembly. The Hex hole locks the screw jack in its place.

FIG. 49 20 Series—X Cross Joint with round holes-flat pattern

### Partial Wall Feature

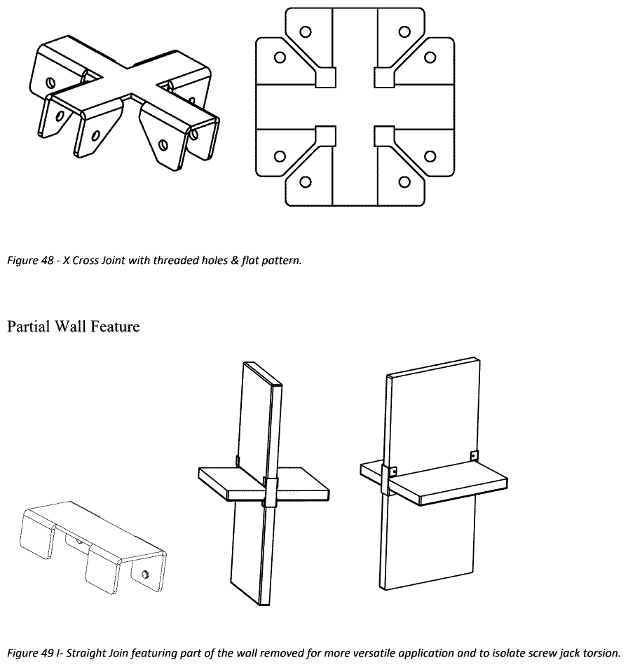

FIG. 50 I-Straight Join featuring part of the wall removed for more versatile application and to isolate screw jack torsion.

FIG. 51 ‘L-corner join’—Partial Wall demonstrated with pavers. Useful for type of join for stabilizing garden bed walls or for assembling shelving, as a substitute T junction.

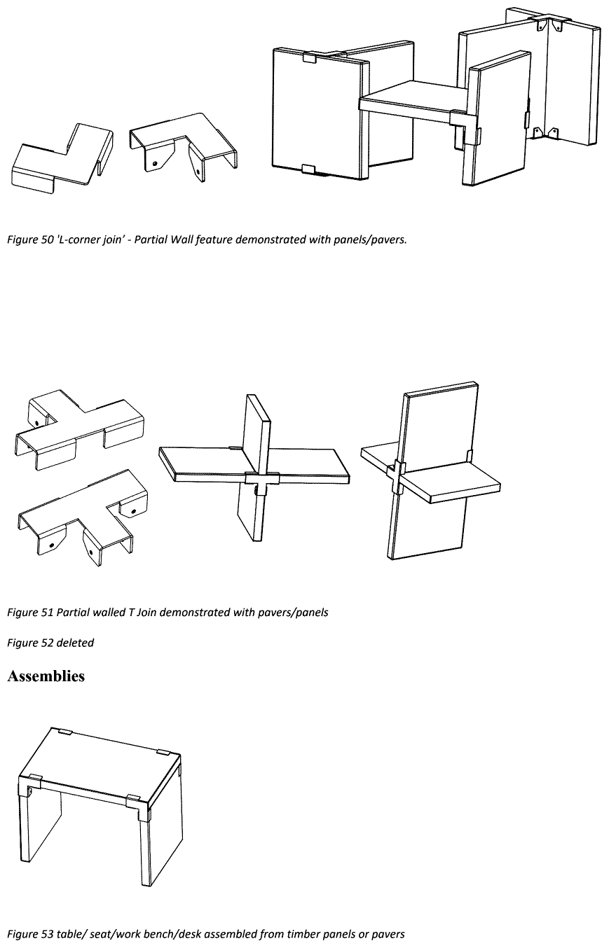

FIG. 52—deleted

FIG. 53—deleted

### Assemblies

FIG. 54 Paver stand, table, or seat

FIG. 55 open ended rectangular prism assembled with porcelain pavers (container/planter pot)

FIG. 56 Garden bed assembly-assembled with concrete pavers.

FIG. 57—deleted

FIG. 58 Matrix structure assembled with double layered (laminated) porcelain pavers—(firewood storage unit)

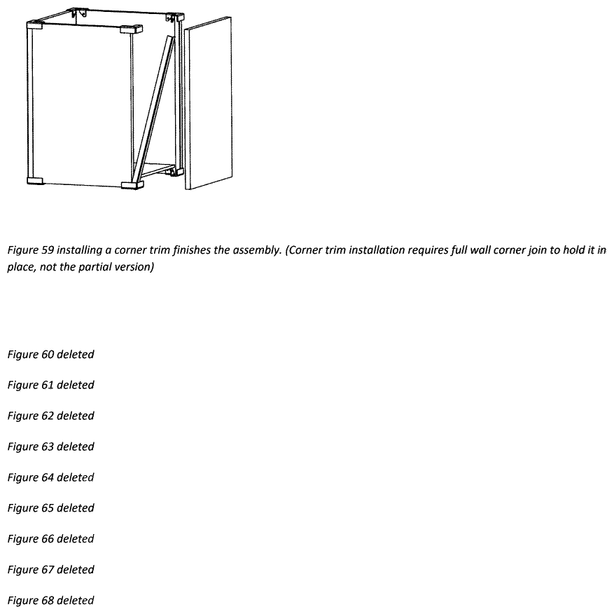

FIG. 59—deleted

FIG. 60 joining pavers/tiles at edge corners allows paver/tile to be inserted as base. (Example: Tile: 600*300 & 300*300. Or Pavers: 600*400 &400*400)

FIG. 61 installing a corner trim finishes the assembly. (Corner trim installation requires full wall corner join to hold it in place, not the partial version)

FIG. 62 20 series hinges separated

FIG. 63 20 series hinges assembled

FIG. 64 ‘open ended rectangular prism’ assembled with pavers, 20 series corner joins and hinge components.

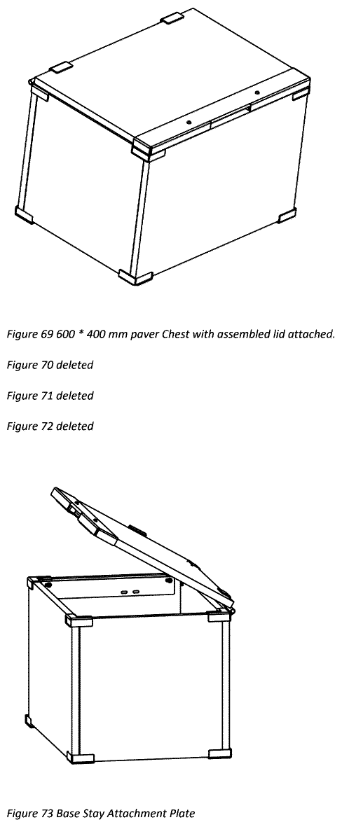

FIG. 65A 20 mm porcelain paver hinged to an ‘open ended rectangular prism’ assembled from 20 mm porcelain pavers.

FIG. 66 top perspective showing gap due to overlap of pavers in the box assembly

FIG. 67 bottom part to 600 mm chest lid attachment.

FIG. 68 Top part of chest lid attachment showing recess as a handle.

FIG. 69 exploded view of chest lid attachment with ‘nut and bolt’ fixings. (‘Furniture bolt and nuts’ are preferred)

FIG. 70—deleted

FIG. 71 20 series 600*400 mm Chest with assembled lid attached.

FIG. 72—deleted

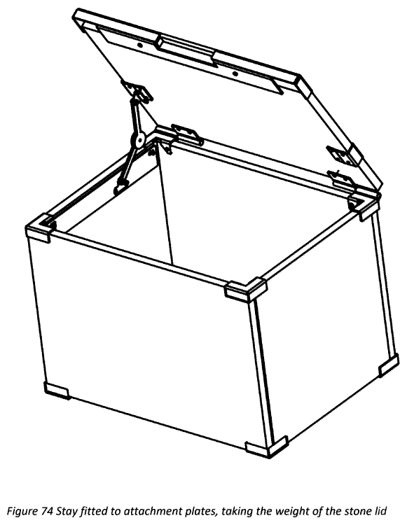

FIG. 73—deleted

FIG. 74—deleted

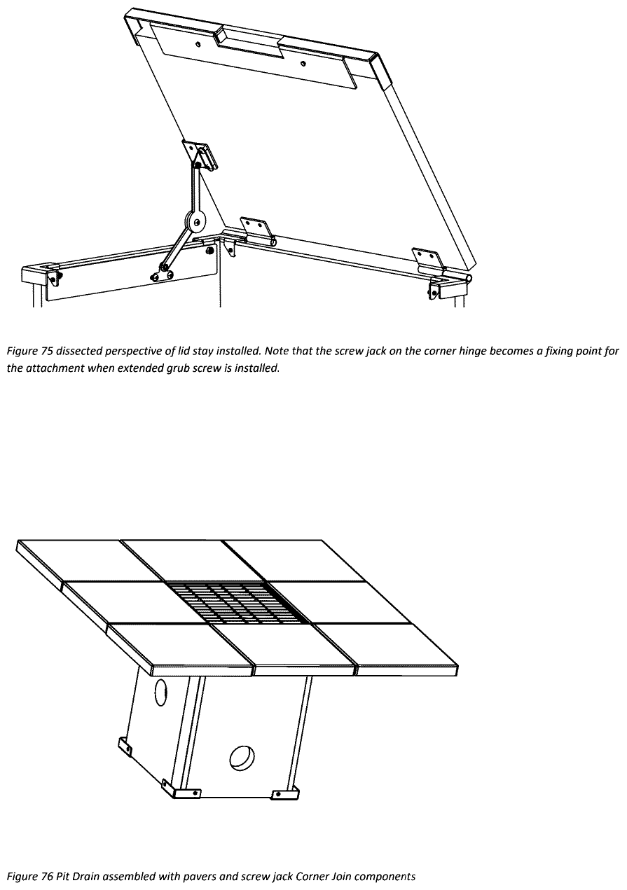

FIG. 75 Base Stay Attachment Plate

FIG. 76 Stay fitted to attachment plates, taking the weight of the stone lid

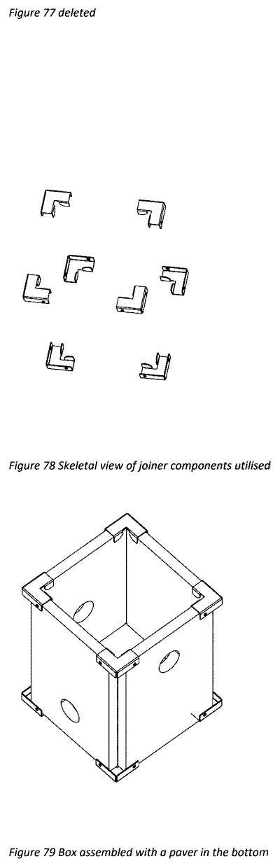

FIG. 77 dissected perspective of lid stay installed. Note that the screw jack on the corner hinge becomes a fixing point for the attachment when extended grub screw is installed.

FIG. 78—deleted

FIG. 80 Skeletal view of joiner components utilized

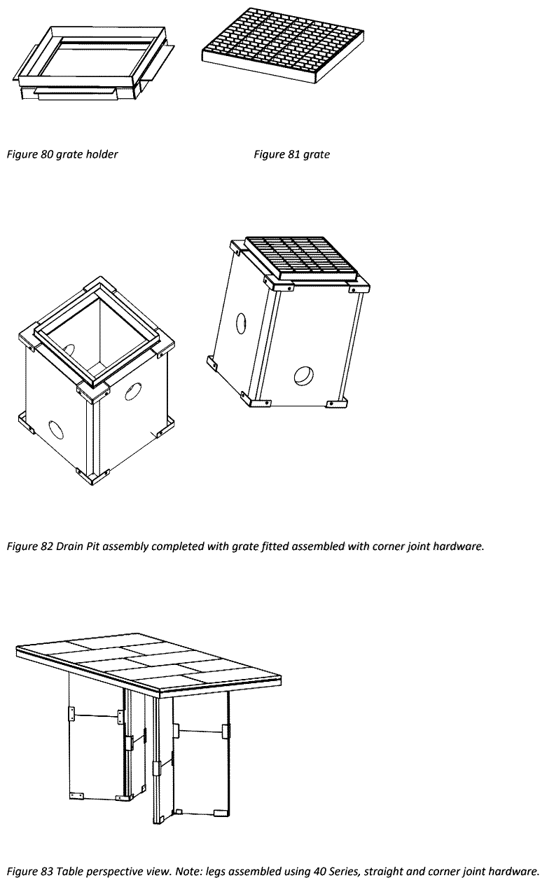

FIG. 81 Box assembled with a paver in the bottom

FIG. 82 grate holder

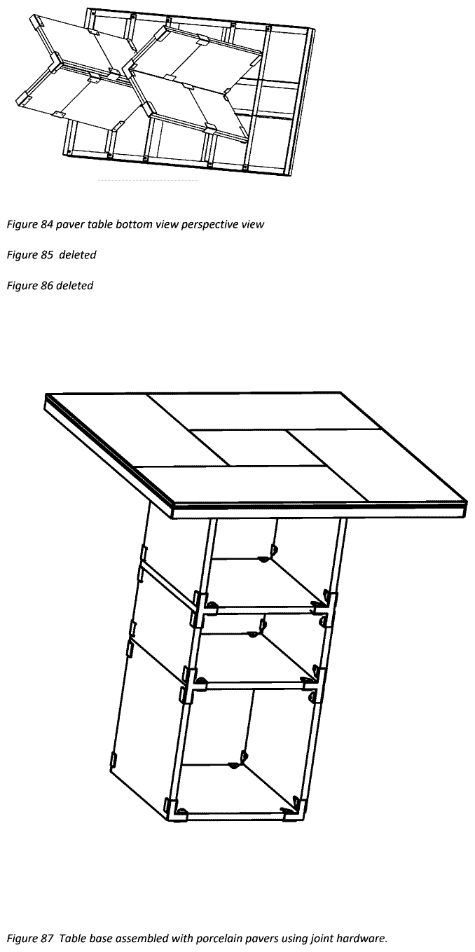

FIG. 83 grate

FIG. 84 Drain Pit assembly completed with grate fitted. (The seams can be caulked, and the pit can be back filled with concrete.)

FIG. 85 Sommerville Table perspective view. Note: legs assembled using 40 Series, straight and corner joiners.

FIG. 86 Sommerville table bottom view perspective view

FIG. 87—deleted

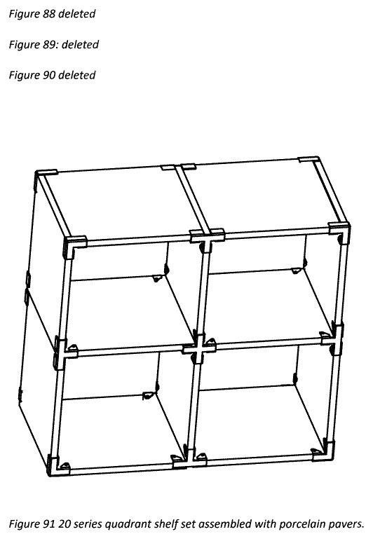

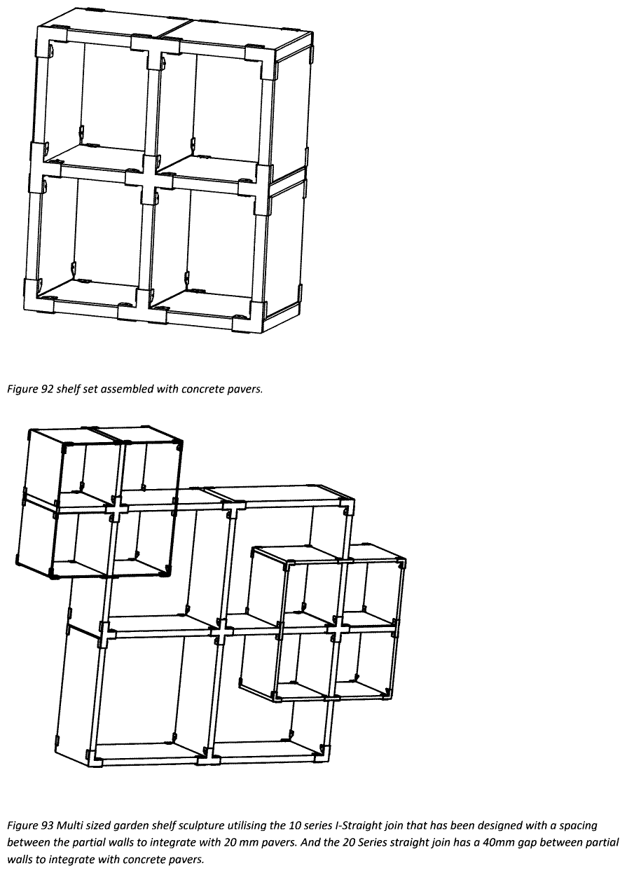

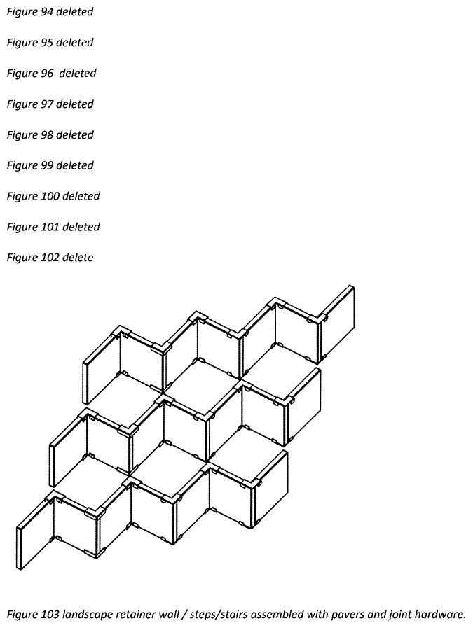

FIG. 88—delete.

FIG. 89 Metrino Table assembled with porcelain pavers using 20 series joiners and a tabletop frame assembled by a similar method to the Somerville table shown in previous drawings.

FIG. 90—deleted

FIG. 91: Shelf unit made from 450 mm×450 mm tiles, assembled with Partial wall-Corner joins. The Screw Jack clamp style fixing allows shelves to be adjusted to any position, added or removed with out damage to structural elements.

FIG. 92—deleted

FIG. 93 20 series quadrant shelf set assembled with porcelain pavers.

FIG. 94 shelf set assembled with concrete pavers using 40 series joiners.

FIG. 95 Multi sized garden shelf sculpture utilizing the 10 series I-Straight join that has been designed with a spacing between the partial walls to integrate with 20 mm pavers. And the 20 Series straight join has a 40 mm gap between partial walls to integrate with concrete pavers.

FIG. 96—deleted

FIG. 97—deleted

FIG. 98—deleted.

FIG. 99—deleted

FIG. 100—deleted

FIG. 101—deleted

FIG. 102—deleted

FIG. 103—deleted

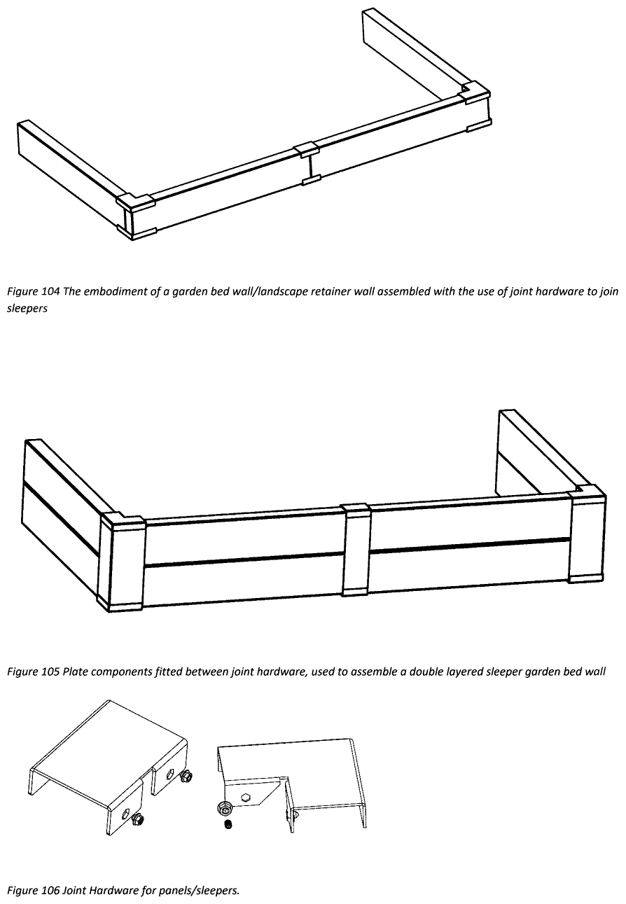

FIG. 104—deleted

FIG. 105 landscape retainer wall assembled with concrete to form a recessing matrix for an embankment in a garden (zig zag wall structures are renowned for stability.

FIG. 106 80 Series Joints demonstrating use with concrete sleepers

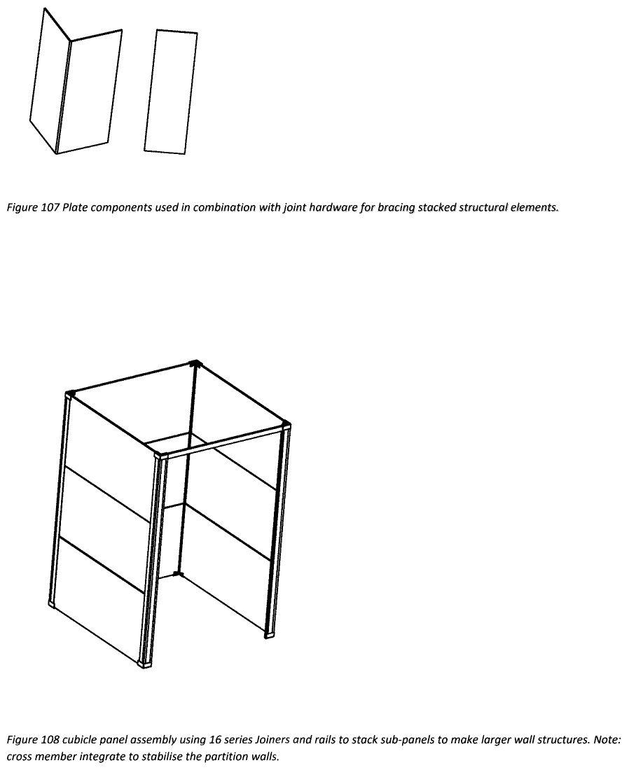

FIG. 107 Plate components used to assemble a double layer concrete sleeper garden wall

FIG. 108 80 series components

FIG. 109 plate components used to in combination with joins to for bracing stacked structural elements.

FIG. 110 cubicle panel assembly using 16 series Joiners and rails to stack sub-panels to make larger wall structures. Note: cross member integrate to stabilize the partition walls.

FIG. 111 the corner joint screw jacks engage with the panels directly (correction: rail is missing screw jacks that hold the tiles in the rail.)

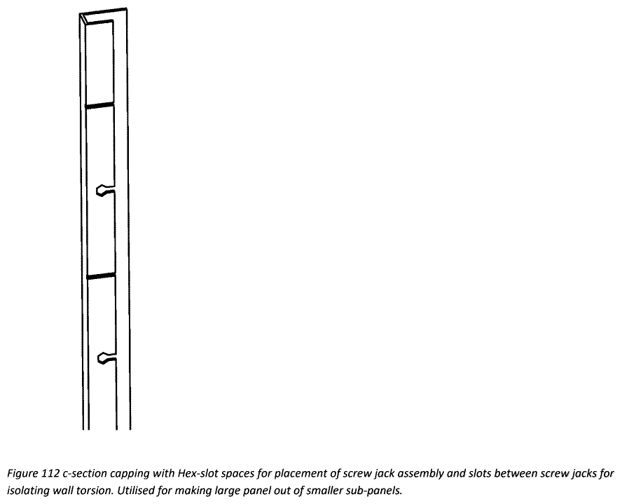

FIG. 112 top view of tile engaging the corner joint

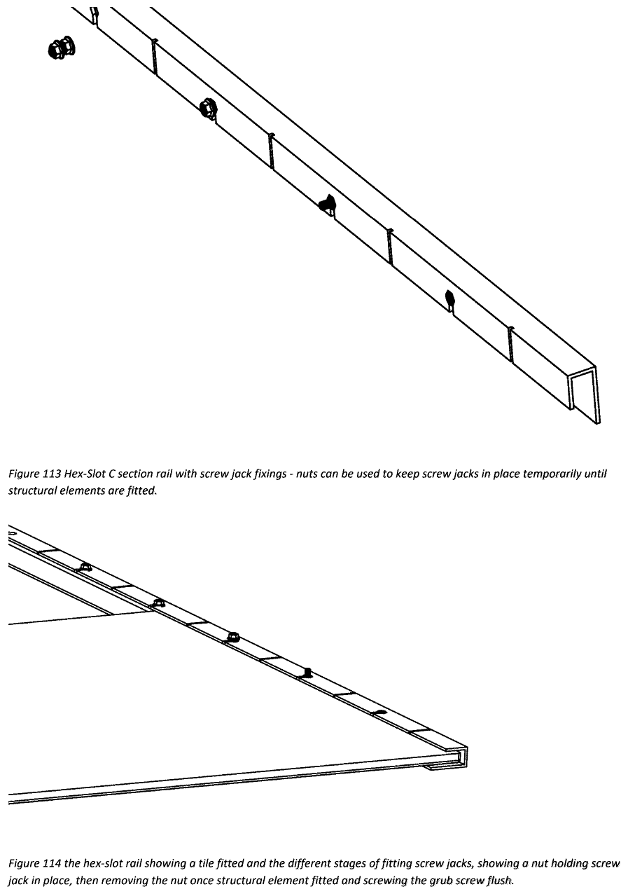

FIG. 113 Top view of corner joint with rectangular hollow section (RHS) to fill the space on a return when there is no wall

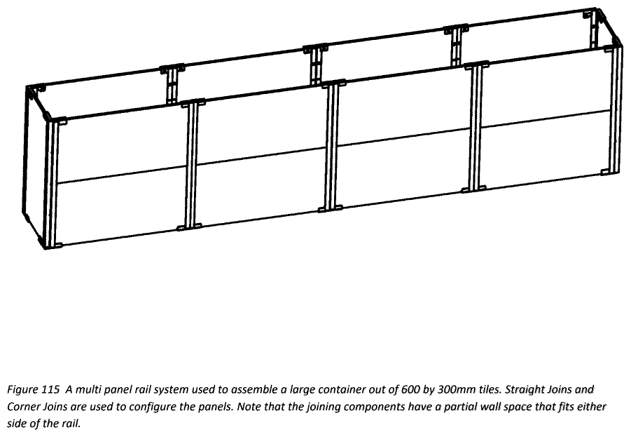

FIG. 114 c-section capping with Hex-slot spaces for placement of screw jack assembly and slots between screw jacks for isolating wall torsion. Utilized for making large panel out of smaller sub-panels.

FIG. 115 Hex-Slot C section rail with screw jack fixings—nuts can be used to keep screw jacks in place temporarily until structural elements are fitted.

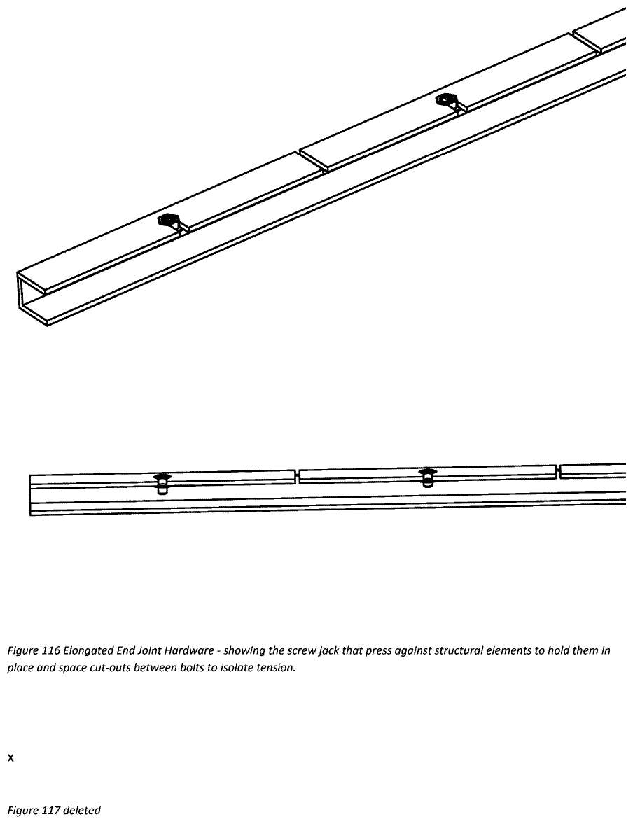

FIG. 116 the hex-slot rail showing a tile fitted and the different stages of fitting screw jacks, showing a nut holding screw jack in place, then removing the nut once structural element fitted and screwing the grub screw flush.

FIG. 117A multi panel rail system used to assemble a large container out of 600 by 300 mm tiles. Straight Joins and Corner Joins are used to configure the panels. Note that the joining components have a partial wall space that fits either side of the rail.

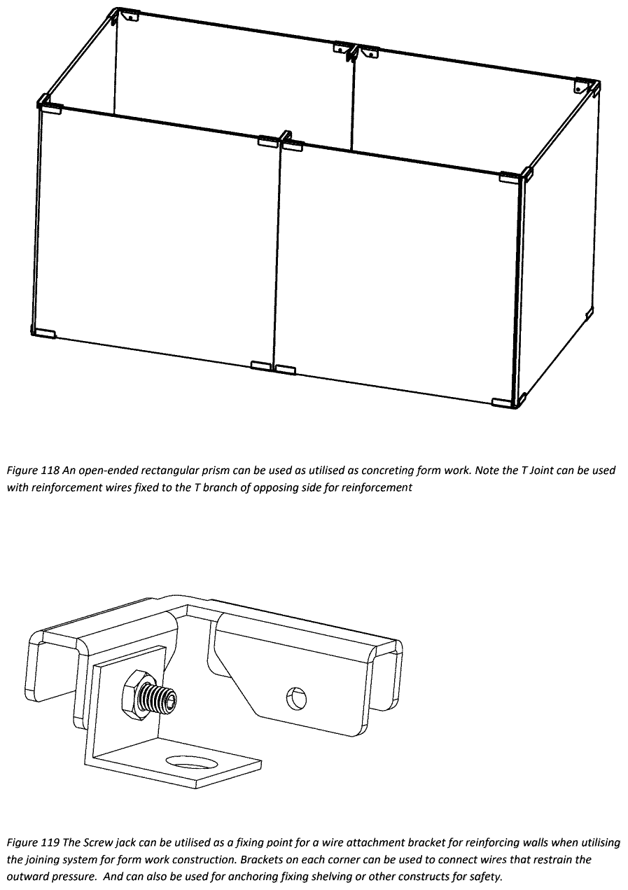

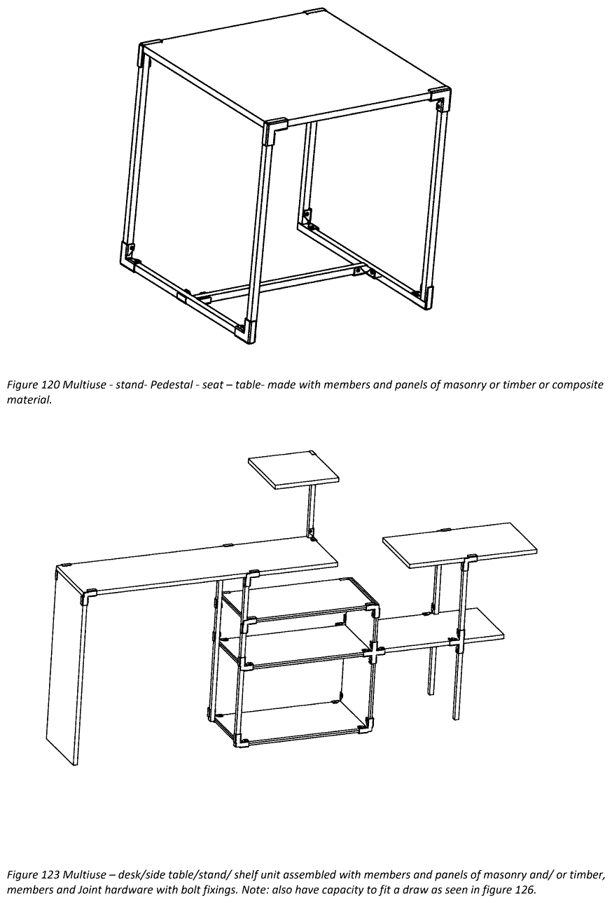

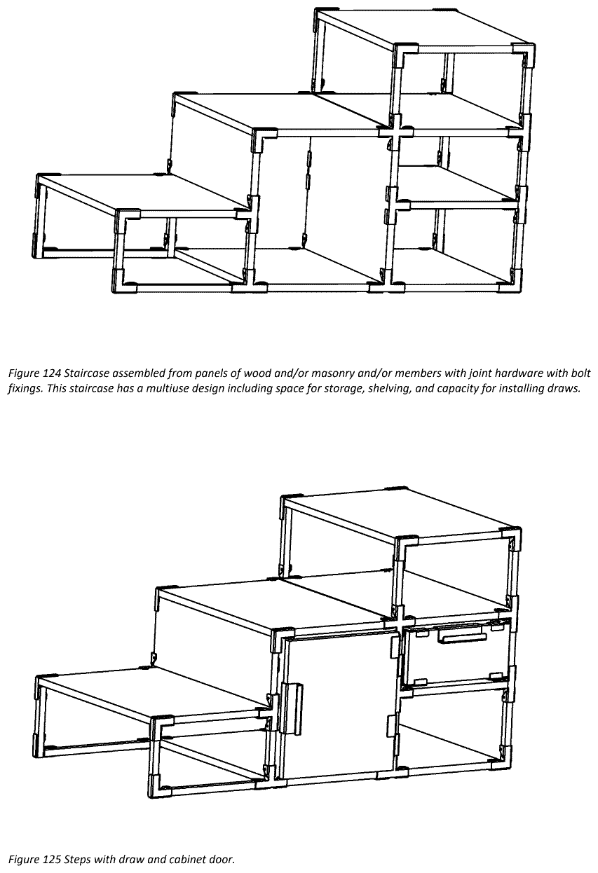

FIG. 118 side view showing the screw jack that press against structural elements to hold them in place.

FIG. 119 Multi material joining. 1200×1200 plywood panel joined to a 1200×1200 porcelain tile (part way through assembly—missing bottom corner joint).

FIG. 120 An open-ended rectangular prism can be used as utilized as concreting form work. Note the T Joint can be used with reinforcement wires fixed to the T branch of opposing side for reinforcement.

FIG. 121 The Screw jack can be utilized as a fixing point for a wire attachment bracket for reinforcing walls when utilizing the joining system for form work construction. Brackets on each corner can be used to connect wires that restrain the outward pressure.

FIG. 122 a multi-use stand/seat/table/pedestal assembled with a paver and members for a leg/base structure.

FIG. 123 Multiuse—desk—side table—stand—shelf made with members and panels of stone and/or timber

FIG. 124 Staircase assembled from panels of wood and/or masonry and/or members with joint hardware with bolt fixings. This staircase has a multiuse design including space for storage. shelving. and capacity for installing draws.

FIG. 125 Steps with draw and cabinet door.

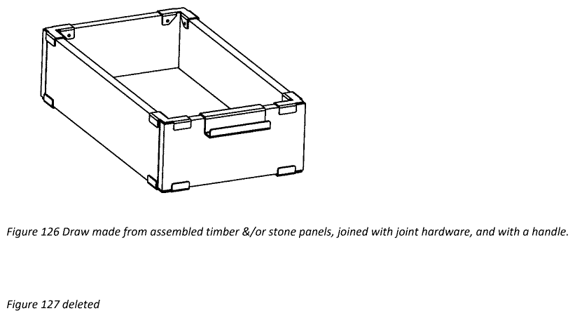

FIG. 126 Draw made from assembled timber &/or stone panels, joined with joint hardware, and with a handle.

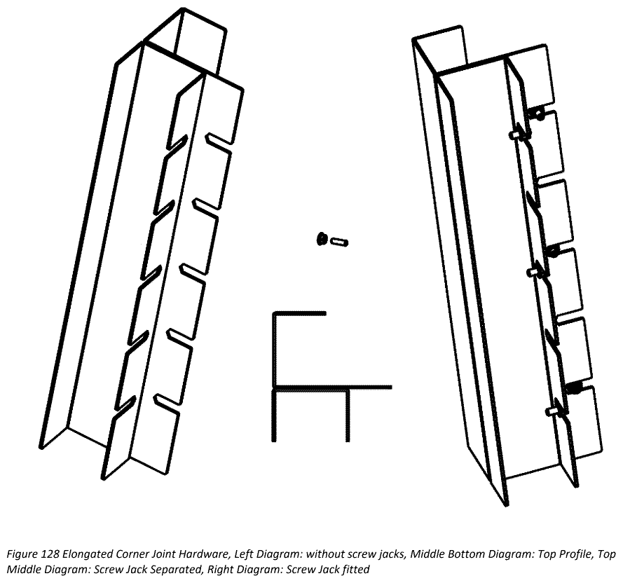

FIG. 127—deleted

FIG. 128 Elongated Corner Joint Hardware, Left Diagram: without screw jacks, Middle Bottom Diagram: Top Profile, Top Middle Diagram: Screw Jack Separated, Right Diagram: Screw Jack fitted

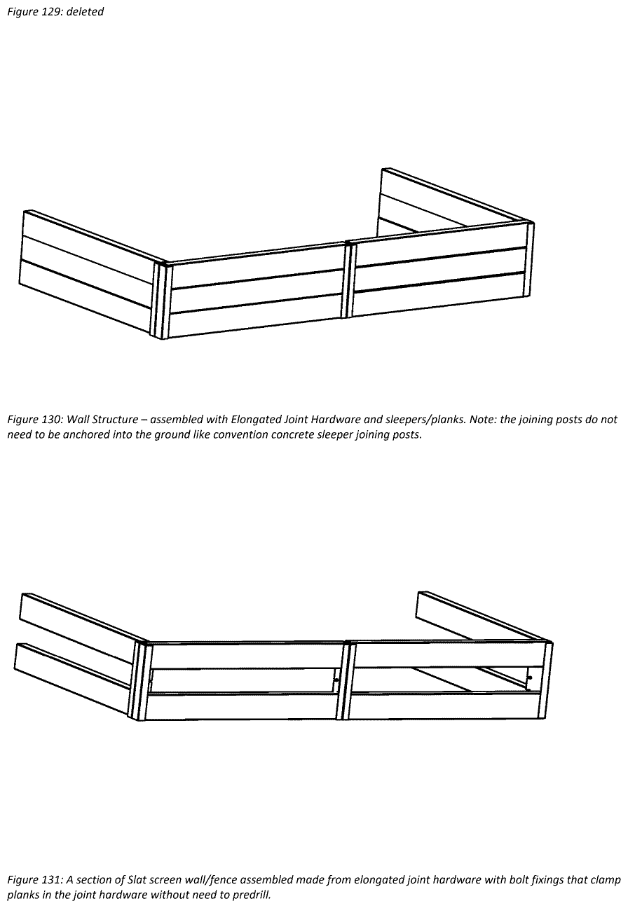

FIG. 129:—deleted

FIG. 130: Wall Structure—assembled with Elongated Joint Hardware and sleepers/planks. Note: the joining posts do not need to be anchored into the ground like convention concrete sleeper joining posts.

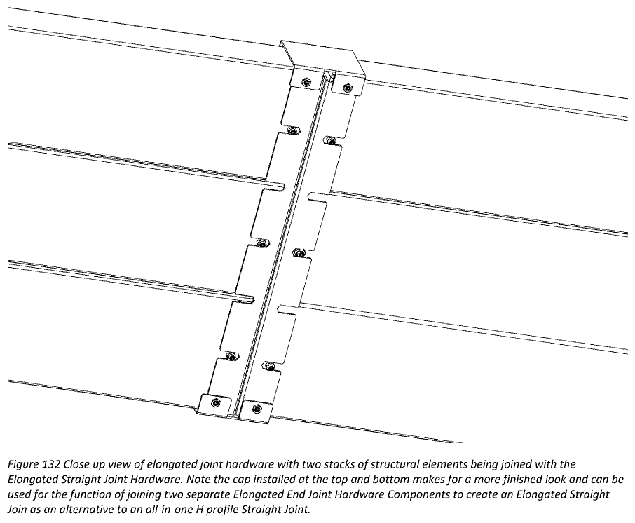

FIG. 131: A section of Slat screen wall/fence assembled made from elongated joint hardware with bolt fixings that clamp planks in the joint hardware without need to predrill.

FIG. 132 Close up view of elongated joint hardware with two stacks of structural elements being joined with the Elongated Straight Joint Hardware. Note the cap installed at the top and bottom makes for a more finished look and can be used for the function of joining two separate Elongated End Joint Hardware Components to create an Elongated Straight Join as an alternative to an all-in-one H profile Straight Joint.

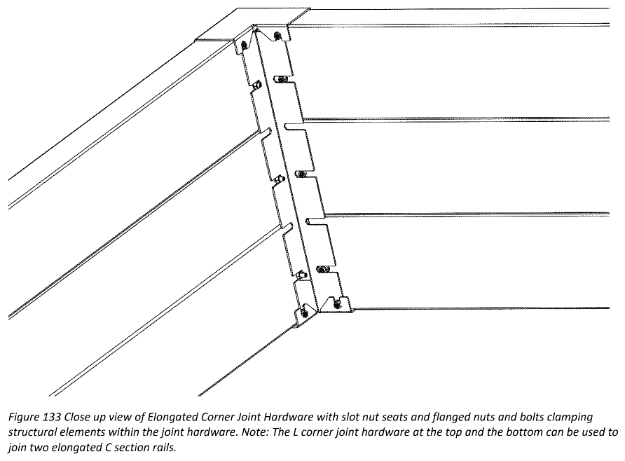

FIG. 133 Close up view of Elongated Corner Joint Hardware with slot nut seats and flanged nuts and bolts clamping structural elements within the joint hardware. Note: The Caps at the top and the bottom make for a more finished appearance and can be used to join separate parts to an alternative form of elongated corner joint hardware as opposed to an all-in-one embodiment.

### DETAILED DESCRIPTION OF EMBODIMENTS

The preferred embodiments of this invention are the joint components. Particularly the “C” cross section Joint components with the L, T or X profile.

In general terms the joint hardware components commonly feature pairs of retainer plates with a central connecting plate between to form the ‘C’ cross section profile channel embodiments.

The central connecting plate forms a either of the L, T, X profiles when view flat from above: the retaining plates extend at 90 degrees from the longitudinal edges of the central connecting plate in the same direction to form the three channel shaped embodiments of L, T, X joint components.

the L, T, X joint hardware features a threaded hole or nut seat in at least one of the retaining plates of each branch of the L, T, X shape. The threaded holes are for the placement of threaded bolts to be installed with the end protruding inwards to press against the structural elements, creating a force that clamps-holds the structural element against the opposing retaining plate when tightened.

The nut seats are used for the installation of a flanged nut as an alternative form of removable and replaceable threaded hole.

The joint hardware are of a predetermined size primarily based on the distance between retainer plates to allow for capacity for joining commonly available structurally rated panels and members for the assembly of furniture, walls, and landscape constructs from timber members, metal rectangular and square hollow section tube, stone and timber panels suitable for work top benches and pavers.

The unique aspect of the said joint hardware is the compatibility usefulness of joining pavers, sleepers and previously mentioned commonly available structurally rated building materials. To be fit for this application of joining said materials it is deemed that the structural element retaining plates be 20-95 mm apart.

The main four joint hardware component of the I, L, T, X are preferred to be made from folded sheet metal that is rigid enough to have tensile strength to withstand the resistant force that occurs when the holding bolt of the screw jack is tightened, yet ductile enough to flex rather than break.

The thickness is one aspect of the adjusting the said balance between ductile and tensile characteristic however many other factors may have influence such as composition of the material of the retainer plate, and processing of the retainer by stressing the metal material may also have an influence. In summary the thickness of the retainer plates is to be left as a predetermined thickness depending on the material of the joint components and the particular application of the joint hardware.

The material of the retainer plates may be made from sheet metal.

1. A bracketed system of joinery, for joining and assembly, comprising joining components and attachment accessories used to join masonry and non-masonry structural elements; being suitable for joining plywood panels, masonry pavers, masonry floor and wall tiles of ceramic and porcelain composition and masonry sleepers, aerated concrete panels using a range of components with screw jacks installed in the side walls to apply adjustable tension to hold and release structural elements.

2. A bracketed system of joinery of claim 1, comprising a system of componentry with each component having U or C section profiled walls, and the component configurations consist of ‘I’—Straight Join, ‘L’—Corner join, ‘T’—Junction and ‘X’—Cross Join with the side walls of the c-section protruding at 90 degrees from the central plane so that the configured C section profiled walls fits over the top or bottom edges of structural elements being joined, as bracing joints for range of orthogonal joins.

3. A bracket system of joinery of claim 1, comprising componentry in the form of U or C section profiled walls that have a configuration whereby: the flat face of the central plane has the figurative structural form of an ‘I’ or of a straight oblong planar profile when viewed from above and opposing side walls protrude along the longitudinal edges at 90 degrees to the central plane in the same direction forming the linear configuration of c-section profile.

4. A bracketed system of joinery of claim 1, comprising componentry in the form of U or C section profiled walls that have a configuration whereby: the flat face of the central plane has the figurative structural form of a ‘L’, or the central face forms a 90 degree right-angle elbow when viewed from above and the opposing side walls of the c-section protrude at 90 degrees to the central plane to form the ‘L’ shaped c-section configuration.

5. A bracketed system of joinery of claim 1, comprising componentry in the form of U or C section profiled walls that have a configuration whereby: the flat face of the central plane has the figurative structural form of a ‘T’; or the central face forms a profile that branches at 90 degrees on both sides of one end of a length; and the opposing side walls of the c-section protrude at 90 degrees to the central plane to from the ‘T’ shaped c-section configuration.

6. A bracketed system of joinery of claim 1, comprising componentry in the form of U or C section profiled walls that have a configuration whereby: the flat face of the central plane has the figurative structural form of a ‘X’; or the central face forms a profile that branches all four sides from a square midpoint; and the opposing side walls of the c-section protrude at 90 degrees to the central plane to form a ‘X’ shaped c-section configuration.

7. A system of joinery as identified by prior art referred to as ‘glass clips’ with componentry C section profiled walls, and the component range consisting of ‘L’, ‘T’ and ‘X’-join configurations with distance between walls to a maximum of 14.5 mm, and not having an ‘I’ straight, join and another ‘glass clip’ system including the ‘I’ straight join but is limited to 12.5 mm space between c-section walls and with component wall thickness not greater than 1.6 mm, wherein the improvement comprises (making clips for larger structural elements) increasing distance between side walls of the c-section to a range from 16 and greater with wall thickness increased to 2 mm or greater and the range of components for the main joining configuration consists of the I, L, T and the X join.

8. A bracketed system of joinery of claim 2-7, used for assembling natural stone pavers, timber panels, or other structural elements, whereby there is a distance between opposing c-section side walls ranging from 16 mm-19 mm.

9. A bracketed system of joinery of claim 2-7, used for assembling masonry pavers, timber panels or other structural elements, whereby there is a distance between the opposing walls of the c-section ranging from 20 mm-39 mm.

10. A bracketed system of joinery of claim 2-7, used for assembling masonry pavers or other structural elements, wherein the improvement is characterized by a distance between opposing c-section side walls ranging from 40 mm to 50 mm.

11. A bracketed system of joinery of claim 2-6, for connecting masonry sleepers, aerated concrete panels or other structural elements, wherein the improvement is characterized by a distance between opposing c-section sidewalls ranging from 51 mm to 110 mm.

12. A bracketed system of joinery of claim 2-11, for joining structural elements whereby:
the opposing sidewalls feature a threaded hole.

13. A bracketed system of joinery of claim 2-11, for assembling structural elements whereby: the opposing sidewalls of the c-section configuration feature a non-threaded hole.

14. A bracketed system of joinery of claim 2-11, for assembling structural elements, whereby: the sidewalls of the c-section configuration feature a cage nut installation or slotted holes for attaching and detaching a cage nut.

15. A bracketed system of joinery of claim 2-11, for assembling structural elements, whereby the sidewalls of the c-section configuration feature installation of a nut-insert.

16. A bracketed system of joinery of claim 2-11, for assembling structural elements, whereby for the sidewalls of the c-section configuration feature a hexagonal shaped holes in the sidewalls.

17. A system of joinery (reference prior art: ‘glass clips’) consisting of a system of componentry having U or C section profiled walls with ‘I’, ‘L’, ‘T’ and ‘X’-join configurations wherein the improvement comprises increasing distance between the c-section side walls to a range from 16 mm or greater; the walls of the components are 2 mm or greater and the sidewalls of the c-section components feature hexagonal shaped holes for installing a flanged nut as part of a detachable screw jack sub-assembly.

18. A system of joinery (reference prior art: ‘glass clips’) consisting of a system of componentry having U or C section profiled walls with ‘I’, ‘L’, ‘T’ and ‘X’-join configurations wherein the improvement comprises increasing distance between the c-section side walls to a range from 16 mm or greater; the walls of the components are 2 mm or greater; the sidewalls of the c-section components feature slot shaped cut-outs that extend from the extend from the edge for insertion of a flanged nut as part of a detachable screw jack sub-assembly.

19. The bracketed system of joinery of claim 2-7, for assembly of structural elements, whereby for placement of flanged nut as an alternative thread installation for a screw jack sub-assembly, the c-section sidewalls feature a slot shaped space extending from the edge of the component wall or a hexagonal hole in the component wall or a hexagonal hole with a slot connecting the hole to the outer edge of the component wall for insertion of a flanged nut, the alternative thread installation for a detachable screw jack assembly.

20. The bracketed system of joinery of Joinery according to claim 2-7, whereby the c-section walls feature holes for the insertion of threaded cage nuts, rivet inserts or any other thread by any other suitable means of installing a detachable thread insertion.

21. The bracketed system of joinery according to claim 17-20, whereby the surface of the wall of the c-section configuration, at the location of the screw jack placement holes or cut-outs is recessed so the flange of the nut interfering with structural elements being joined is minimized.

22. The bracketed system of joinery of claim 3, whereby to eliminate the torsion from one screw jack effecting another on the same wall, a space in the wall is created between screw jacks.

23. The bracketed system of joinery of claim 2, 3, 7, 17,18, 19 whereby the ‘I’—straight join configuration features a space between screw jacks on the sidewall to isolate the effects of torsion on the component wall or to allow a structural element to pass through the component walls.

24. The bracketed system of joinery of claim 1, 2, 5, 7, 17,18, 19 whereby the ‘T’ join has a space in the sidewall at the location of where the branch of the ‘T’ intersects, creating a space in the sidewall to allow structural elements fitted into the stem of the ‘T’ to pass through the component wall, effectively allowing for use as a rudimentary form of ‘X’—cross junction.

25. The bracketed system of joinery of claim 1, 2, 4 whereby the ‘L’—right angle—corner join has part of the wall removed on both sides at the apex of the 90-degree corner join, to facilitate greater versatility in application by allowing structural elements being joined to pass through.

26. The bracketed system of joinery of claim 1-10, whereby any of the Joins referred in claim 2 as ‘I’, ‘T’, ‘L’, ‘corner join’, ‘three-way junction’, ‘straight join’ have part of the wall removed to facilitate greater versatility in use or improve existing prior art.

27. The bracketed system of joinery of claim 23-26, whereby the space in sidewall of the c-section is equal to or greater than the distance of apposing sidewalls of the c-section to facilitate structural element passing through the component walls and to allow for the effects of flex on the wall when the screw jacks are tightened.

28. A heavy duty bracketed system of joinery of claims 1-11 whereby the componentry is made from sheet metal in mild steel greater than 2 mm in sheet metal wall thickness, with the mild steel having superior ductile qualities compared to stainless steel, being an improvement on prior art.

29. The bracketed system of joinery according to claims 1-11 whereby the joining componentry, made from sheet metal is treated to increase tensile strength by either heat treating, punching holes or slots, pressing indentations or ribs, or altering metal composition or any other suitable means.

30. A system of joinery consisting of joining components according to claims 2-11 whereby the joining componentry has a splayed crimp in the sidewall, so that any edge or edges splays outwards from the opposing walls to assist with fitting the joining component on structural elements when it is a tight fit.

31. A product by process, whereby the joining components described in claims 2-11 or referred or referred to as the ‘I’, ‘L’, ‘T’ or ‘X’ joins, feature a space in the c-section sidewalls to facilitate the pressing of folds from one ‘X’ shaped press mould as opposed to having separate mould for each configuration.

32. The bracketed system of joinery of claim 8-11 whereby: the joining components are made from sheet metal greater than 2 mm in thickness.

33. A bracketed system of joinery consisting of a door or lid attachment that it extends the length of a structural element comprising: two parts, one having the configuration of sheet metal that resembles a tray with on edge missing, made of appropriate size and proportions to fit to the face of a panel structural element, the second having a flat plane with matching width to first said part and a folded edge of similar length to the edges of the first said tray part; with holes that align on both parts when the parts are placed facing together with the folded edge of second mentioned part fitting inside the edge of first mentioned part.

34. The system of joinery of claim 29, whereby: the joining components are made from sheet metal that has a lattice of holes punched through the surface to increase tensile strength.

35. A system of joinery of claim 1, whereby the screw jack assembly comprises, a threaded grub screw or threaded bolt, a matching threaded flanged nut with a head size and shape that fits into a complimentary hole in a joining component wall whereby when mounted the flange nut does not rotate and the flange stops the nut from passing though the hole, therefore providing a thread for a threaded screw bolt to be tightened against a structural element held within the joining component.

36. A method of joining multiple panels into one larger panel consisting of placing tiles/sub-panels in lengths extrusion or folded sheet metal with C or H section profiled walls with the tiles slotting between the walls of the profile: 1) place tiles/sub-panels one after the other along the C (or 2* ‘L’ Angle profiles) or H (or 2 C section profiles) section with C or H section on opposing sides and the joins between tiles running perpendicular to the C or H section lengths. 2) The C section is cut to the length to match the length from first to last tile. 3) depending on the configuration of the partition wall structure the appropriate selection of ‘I’ join, or ‘T’ join or ‘L’ join, or ‘X’ join is attached to the top and bottom corners of the assembled panel. 4) tighten screw jacks tightly to lock the top and bottom tile into position. 5) repeat process of assembling panels and configuring partition wall structure to satisfy design specification.

37. A system of joinery suitable for joining multiple panels to make a large panel structure, consisting of componentry comprising a length of C section profiled walls, with the distance between opposing c section walls being suitable to fit the structural element being joined; and the walls feature hexagonal holes as per claim 16 or slots spaces as per claim 19 or Hex-slot spaces as described in claim 46, spaced along the length of the side wall, for the placement of threaded flange nuts with the hex head matching the size of the placement spaces so that it engages with the component wall when inserted to stop it from rotating when fitted, providing an alternative method of installing threads for screw jack assemblies on demand.

38. A structure formed using the system of joinery of claim 1, wherein the structure is selected from the group consisting of: temporary partitions, exhibitions booths, work benches, shelving units, formwork for concreting, rectangular open-ended prism made from masonry pavers or tiles, garden beds, retainer walls, tables, chests.

39. A concrete formwork structure consisting of panels joined together with the system of joinery of claim 1-7.

40. A Method construction consisting of a process that utilizes concrete form work structure of claim 39 whereby the from-work panels are masonry pavers or tiles, and the formwork becomes a permeant feature encasing the finished concrete

41. A bracketed system of joinery consisting of a bracket for joining structural elements with a screw jack assembly that comprises: a threaded flanged nut mounted into a space or hole in the wall of the bracket component and a threaded bolt screwed into the flanged nut with the length of the bolt protruding through the component wall to apply holding pressure to the side of a structural element when tightened.

42. A bracketed system of joinery for joining structural elements consisting of a hinge formation whereby: the leaf of the hinge is of a length of c-section profile, that has screw jacks features in the walls of the c section and the distance between walls of the c section is 15 mm or greater.

43. A bracketed system of joinery consisting of a hinge component comprising a corner profile as described in claim 4, wherein part of the sidewall at the apex end is folded 180 degrees in the opposite direction of the opposing c-section wall and features a hole for a pin to be mounted into.

44. A structure formed using the bracketed system of joinery of claim 1, where in the structure is selected from the group consisting of: temporary partition walls, exhibition booths, work benches, garden retainer walls, garden boxes, planter pots, tables, shelving units, formwork for concreting, cabinets, chests, firewood storage units, right-angled open-ended prisms, garden edging, drain pits.

45. A bracketed system of joinery for joining structural elements as described in the description.

46. The bracketed system of joinery of claim 1-7, consisting of a detachable screw jack assembly whereby, the c-section sidewalls feature a hexagonal hole in the wall of suitable size to stop a matching sized hexagonal flanged nut from turning and a slot shaped part of the wall removed between the hexagonal hole and edge of the wall, of a width that is wide enough for the threaded bolt to pass through freely yet narrower than the width of the hexagon head of the flange nut.

47. Joining brackets as shown in FIGS. 1-44

48. A design consisting of a X shape centre plane with 90-degree walls

49. A design consisting of a I shape centre plane with 90 degrees walls.

50. The system of joinery of claims 1-11, whereby the joining componentry and attachment accessories are made of sheet metal.

51. The system of joinery of claims 1-11, whereby the joining components and accessories are made from 3D printing.

52. The system of joinery of claims 1-11, whereby the joining components and accessories are made from moulded metal.

53. The system of joinery of claims 1-11, whereby the joining components and accessories are made from plastic.

54. A design consisting of a L shape profile centre plane centre plane with a hexagon hole on the internal walls.

55. A design consisting of a T shape profile centre plane with 90-degree walls and with a hexagon hole on the side walls.

56. A design consisting of a X shape centre plane with 90-degree walls with hexagon holes on the internal walls.

57. A design consisting of a I shape centre plane with 90 degrees walls with a hexagon hole on the side walls.

58. A design consisting of consisting of c-section configured with the flat centre plane forming an ‘L’ shape profile with side walls along the longitudinal sides of the branches of the ‘L’ featuring a slot shape part of wall removed from the edge of the component wall.

59. A design consisting of a c section profile configured to a ‘T’ shape, with the flat centre plane forming the ‘T’ shape when viewing the flat face from above; and with 90-degree walls folded in the same direction along the longitudinal edges and slot shape part of wall removed from the edge of the walls.

60. A design consisting of consisting of c-section configured with the flat centre plane forming an ‘X’ shape profile with side walls along the longitudinal sides of the branches of the ‘X’ featuring slot shapes removed from the edges of side walls.

61. A design consisting of a ‘I’ shape centre plane with 90 degrees walls with spaces at the mid length point on side walls.

62. A design consisting of a rectangular open-ended prism made from pavers joined together with joiners as described in 3-7.

63. A design consisting of a L shape profile centre plane with 90-degree walls.

64. A design consisting of a T shape profile centre plane with 90-degree walls

65. The Bracketed system of joinery of claim 1, consisting of a DIY table top assembly to support pavers or tiles, made to sit upon leg structures assembled from the bracketed system of joinery of claim 1, assembled with nut and bolts and made to support pavers or tiles on a flat plane via a series of cut outs and interlocking layers; consisting of: Perimeter Rails of angle iron whereby the 90 degree angle iron is doubled up to form a ‘T’, with the stem of the ‘T’ consisting of double layer of metal plane, facing inwards that are bolted together with counter sunk bolts and nuts. The bottom layer or top layer is removed at the ends, with the layer removed being of piece of similar width the Angle iron so a single layer of angle iron can slide into the space, a corresponding removal of either top or bottom layer is removed from the length and width perimeter rails so the side interlock, a removal of the 2 sections of the bottom layer of the ‘T’ stem on opposing sides at the point where the leg structure is to be placed, the distance apart of the removed section being the width of the leg structure, with the section removed being of a width suitable for the placement of cross rail made from 90 degree angle iron. With at least one rail that runs from end to end or side to side, perpendicularly crossing over the top of the previously mentioned cross rails. Being right angle iron part of he right angle wall facing down is removed to allow cross over of rails with flat faces layered together. The crossing over rail sits in the T stem (combo L—perimeter rail) that has a top layer segment part removed of similar width to the width of the angle slotting in. The crossover rail or thereof and corresponding cut out for placement are placed at the join of pavers or tiles. So, both the perimeter edge (being T stem) and the cross over rails act as support to the pavers to be placed on. With the cross over rail or plural thereof being placed in a position to support the join of two pavers or tiles.

66. A Hinge assembly suitable for joining pavers, consisting of a pin and tube that form the knuckle, with the leaf of each sub part being C-section configured with screw jacks featured in the C-section side walls; the pin is positioned along the longitudinal fold line and extends beyond the end of the c section walls. A second sub-part to the hinge set features a tube that that is positioned parallel to the longitudinal fold line flush with the end of the c-section embodiment in such a way that when paired together it fits over the pin, with the two parts engaged whereby they pivot at the pin and sleave axis.

67. The bracketed system of joinery of claim 66, suitable for joining pavers in a hinge set whereby the distance between the c-section walls is 20 mm and greater and the walls of the c-section component are 2 mm and greater.

68. The bracketed system of joinery of claim 66 whereby one part of the paired hinge sub-parts has the configuration of a corner join as described in claim 4.

69. A bracketed system of joinery, for extending the length of a standard sized paver with a sheet metal embodiment that also includes a handle hold for use as a chest lid or cabinet door, consisting of: apposing planes that fit to the front and back face of the paver with sides that are folded 90 degrees, overlapping the opposing edge, with the folded wall length being of a length that keeps to the thickness of the paver, and the opposing faces featuring at least two holes that align for furniture nut and bolts to be tightened together so as to create a clamping effect that hold the sheet metal planes to the paver; and the dimensions of the front and back panels extending the coverage of the paver to suit application, with the extension providing a cavity space for a folded recess in the edge that acts as a hold or handle when used as a lid or door.

70. A bracketed system of joinery as per claim 1, suitable for joining multiple structural elements such as sleepers stacked on top of each other, consisting of flat or right-angled plates, equal the height of the stack that fit between the bottom and top joining components, with the component being as described in claim 2-7.

71. A container assembled from paver or tiles joined together with joining components as described in claims 2-7.

72. A drain pit assembled from pavers joined together with joining components as described in claims 2-7.

73. A drain pit assembled from 5 pavers joined together with joining components as described in claims 2-7.

74. A stand or bench assembled from pavers joined together with joining components as described in claims 2-7.

75. A bench seat assembled from pavers joined together with joining components as described in claims 2-7

76. A retainer wall assembled from pavers joined together with joining components as described in claims 2-7.

77. A shelf set assembled from pavers or tiles joined together with joining components as described in claims 2-7.

78. A seat assembled from pavers joined together with joining components as described in claims 2-7.

79. A plant pot container assembled from masonry pavers or tiles joined together with joined components as described in claim 4.

80. A plant pot assembled from porcelain or ceramic tiles joined together with joined components as described in claim 4.

81. A firewood storage unit assembled from pavers joined together with joining components as described in claims 2-7

82. A bracketed system of joinery of claim 1, consisting of a lid stay attachment plate whereby the component is made from folded sheet metal configured into a length of c-section that feature threaded holes placement spaces for screw jacks on one side wall and said side wall extends further, in a direction that is perpendicular to the longitudinal fold line, with a slight bend inwards, after the screw jack placement holes, with the extended section of the side wall featuring holes or spaces in the wall for the attachment of a lid or door stay. The distance between c-section walls being suitable to fit over the edge of a paver or tile and the slight bend is such that when the screw jacks are tightened the flex of the wall from the torsion creates a parallel plane with the section of the bracket wall with stay fixing and the face of the paver.

83. The lid stay attachment plate of claim 82 whereby the screw jack and stay placement spaces or holes are either threaded round holes, either hexagonal, slotted spaces from the edge of the component, hexagonal shape with a slot space opening between hexagonal and the edge of the component wall, or holes for the nut inserts or cage nuts.

84. A bracketed system of joinery consisting of a chest wall stay attachment plate consisting of a metal flat plane with holes for attaching to the chest corner join and corner hinge screw jacks, with the screw jacks featuring an extended threaded bolt or grub screw for attachment of said plate on the side wall for the chest and the plate also featuring holes for the attachment of a stay arm.

85. A chest assembled with pavers joined together with L corner join components of claim 4, hinge components of claim 66-68, a handle of for a lid of claim 69, a stay attachment plate of claim 82-84 for attaching a lid stay.

86. An open-ended right prism, useful as a stand, seat or table consisting of four pavers joined with corner join components of claim 4.

87. A c-section configured multi-use structure, useful as a stand, seat and table consisting of three pavers joined with four corner joins of claim 4.

88. A right-angle prism useful as a multi-use container, useful as a plant pot, storage container, consisting of 5 masonry pavers, whereby 4 pavers are assembled into a right-angle prism using corner joins of claim 4, and a fifth paver is inserted into the bottom of the prism where it rests on the top of the corner joins of claim 4.

89. A weather resistant stone shelving unit useful for storing things, consisting of 12 masonry pavers, assembled using two ‘X’—cross joins of claim 6, eight ‘T’—junction joins of claim 5 and eight ‘L’—corner joins of claim 4 to join the pavers into a quadrant shelf set.

90. A drain pit assembly consisting of four pavers joined together in an open-ended right-angle prism, with corner joiners as described in claim 3 joining the pavers at the bottom and top of each join; a grate fits consisting of a grate holder that has a layer of right angle facing down to fit with the inside edge of the pit between the joining brackets and a second right angle layer facing up that act as a placement space for the grate.

91. A drain pit assembly according to claim 90 whereby there is no base paver and the space at bottom is left vacant to be filled with concrete.

92. A drain pit assembly according to claim 90 whereby the pavers on the sides have holes for fitting drainpipes.

93. A system of joinery suitable for joining multiple structural elements to make a large panel structure, consisting of a rail with C or H section profiled walls, with the distance between opposing side walls suitably wide enough to fit structural elements being joined; the C or H-section walls of the rail feature threaded holes spaced even along the length of at least one side wall for the placement of threaded bolts; the wall with the threaded holes for the placement of bolts also feature slot shaped parts of the wall removed between each threaded hole to isolate the effects of wall tension, with the slots positioned perpendicular from the edge of the rail. The said c-section rails are placed over the edges of opposing sides of multiple structural elements of equal length that are stacked or placed side by side, with threaded bolts installed and tightened against structural elements to lock the structural elements in the rail to create a larger panel structure.

94. A system of joinery suitable for joining multiple structural elements to make a larger panel structure as described in claim 93, whereby the threaded holes are substituted for cut-outs in the wall for the placement of a flanged nut as an alternative thread installation.

95. A system of joinery suitable for joining multiple structural elements to make a larger panel structure as described in claim 94, whereby the shape of the cut-out has the form of a hexagonal hole.

96. A system of joinery suitable for joining multiple structural elements to make a larger panel structure as described in claim 94, whereby the shape of the cut-out has the form of a hexagonal hole with a slot extending the cut-out between the hexagonal hole and the edge.

97. A system of joinery suitable for joining multiple structural elements to make a larger panel structure as described in claim 94, whereby the shape of the cut-out has the form square or rectangle hole.

98. A system of joinery suitable for joining multiple structural elements to make a larger panel structure as described in claim 94, whereby the shape of the cut-out has the form of a slot creating an open space in the wall from the outer edge ending inwards to towards the centre of the wall.

99. A petition wall structure consisting of wall panels assembled from structural elements joined together with side rails as described in claim 93-98, whereby the wall panels are configured with joiner components as described in claim 3-7.

100. A system of joinery suitable for assembling multiple structural elements either by stacking or placement side by side, whereby the joining brackets of claim 3-7, featuring screw jack fixing; functions with a part consisting of a flat or right angle folded plate that is fitted between the structural element being joined and the joining component side wall and fits between the top and bottom joining components with the said plate being a suitable length to act as a brace to the multiple structural elements.

101. A containment structure assembled with structural elements joined together with components specified in claims 3-7 and/or components specified in claims 93-98.

102. A retainment structure assembled with structural elements joined together with components specified in claims 3-7 and/or components specified in claims 93-98.

103. A walled structure assembled with structural elements joined together with components specified in claims 3-7 and/or components specified in claims 93-98.

104. A concrete formwork structure assembled with structural elements joined together with components specified in claims 3-7 and/or components specified in claims 93-98.

105. A garden bed structure assembled with structural elements joined together with components specified in claims 3-7 and/or components specified in claims 93-98.

106. A table assembly consisting of tabletop assembly of claim 65 bolted to table legs assembled from pavers and/or tiles joined together with components specified in claims 3-7.

107. A system of joinery suitable for joining multiple structural elements to make a larger panel structure as described in claim 94, whereby the shape of the cut-out has the form that stops a flanged nut from rotating and is of a size that is fitting for head of the nut to be inserted whilst the flange of the nut stops the nut from passing through.

108. A bracketed system of joinery of claim 2-11, for assembling structural elements, whereby the sidewalls of the c-section configuration features cut-outs in the sidewalls that are formed to stop a flanged nut from rotating and is of a size that is fitting for the head of the nut to be inserted whilst the flange of the nut stops the nut from passing through, with the flanged nut effectively functioning an alternative thread insert.

109. A system of joinery (reference prior art: ‘glass clips’) consisting of a system of componentry having U or C section profiled walls with ‘I’, ‘L’, ‘T’ and ‘X’-join configurations wherein the improvement consists of cut-outs in the sidewalls that are formed to stop a flanged nut from rotating and is of a size that is fitting for the head of the nut to be inserted whilst the flange of the nut stops the nut from passing through, with the cut-out effectively functioning as a seat for detachable screw jack sub-assembly.
